(19) United States
(12) Patent Application Publication
(10) Pub. No.: US 2026/0339703 A1
(43) Pub. Date: Oct. 29, 2026

(54) NON-BLOCKING EXECUTION FOR BATCHED SAMPLE PROCESSING

(71) Applicant: SambaNova Systems, Inc., Palo Alto, CA (US)

(72) Inventor: Raghu PRABHAKAR, San Jose, CA (US)

(73) Assignee: SambaNova Systems, Inc., Palo Alto, CA (US)

(21) Appl. No.: 19/457,587

(22) Filed: Jan. 23, 2026

Related U.S. Application Data
(60) Provisional application No. 63/748,736, filed on Jan. 23, 2025.

(51) Int. Cl. G06F 9/48; G06F 9/54

(52) U.S. Cl. CPC G06F 9/4881; G06F 9/545

(57) ABSTRACT

Techniques are disclosed for processing a batch of samples using a processor comprising compute units. A system may configure the processor to implement a plurality of layers including at least a first layer and a second layer, wherein the first layer comprises a plurality of operators including at least a first operator and a second operator. The system may execute the plurality of layers for the batch of samples, wherein execution comprises at least one of pipelining samples of the batch across the operators of the first layer such that the first operator executes for a first sample simultaneously with the second operator executing for a second sample, or a sample of the batch beginning execution of the second layer before all samples of the batch have completed the first layer.

### BACKGROUND

### Technological Field

This application is related to US Provisional Patent Application Number 63/748,736 titled “SPECULATIVE DECODING ON THE SAMBANOVA SN40L RECONFIGURABLE DATAFLOW UNIT” filed on Jan. 23, 2025. The related application is hereby incorporated by reference for all purposes.

The present disclosure relates generally to processor architectures and execution methods, and more particularly to techniques for non-blocking execution of batched sample processing across operators and layers.

### Incorporations

The following are incorporated by reference for all purposes as if fully set forth herein:
Prabhakar et al., “Plasticine: A Reconfigurable Architecture For Parallel Patterns,” ISCA '17, Jun/ 24-28, 2017, Toronto, ON, Canada;
U.S. patent application Ser. No. 16/197,826, filed Nov. 21, 2018, entitled “CONFIGURATION LOAD OF A RECONFIGURABLE DATA PROCESSOR”; and
U.S. patent application Ser. No. 16/198,086, filed Nov. 21, 2018, entitled “CONFIGURATION UNLOAD OF A RECONFIGURABLE DATA PROCESSOR.”

### Description of Related Art

Artificial intelligence (AI) and machine learning have driven demand for specialized processors capable of executing neural network models efficiently. Such processors may include graphics processing units (GPUs), tensor processing units (TPUs), reconfigurable dataflow processors, and other accelerator architectures comprising compute units. These processors are often deployed in data centers and cloud computing environments to serve inference requests.

Neural network inference typically involves executing a sequence of layers, where each layer comprises multiple operators such as matrix multiplications, attention mechanisms, and normalization functions. Large language models (LLMs) and other autoregressive models generate output tokens sequentially, where each output token depends on previously generated tokens.

The sequential nature of autoregressive token generation presents challenges for achieving high throughput and efficient utilization of processor resources. Various techniques have been explored to accelerate token generation. As AI models continue to grow in size and complexity, and as demand for real-time inference increases, there remains a need for improved approaches that can more fully utilize available processor resources.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates a block diagram of an example speculative decoding system configured to generate output tokens using a draft model and a target model, in accordance with example embodiments of the disclosure.

FIG. 2A illustrates a schematic diagram of example within-layer pipelining of batch samples across operators of a layer, in accordance with example embodiments of the disclosure.

FIG. 2B illustrates a schematic diagram of the example within-layer pipelining of FIG. 2A across time, in accordance with example embodiments of the disclosure.

FIG. 3A illustrates a schematic diagram of example inter-layer streaming in which a sample begins execution of a subsequent layer before all batch samples have completed execution in a prior layer, in accordance with example embodiments of the disclosure.

FIG. 3B illustrates a schematic diagram of the example inter-layer streaming of FIG. 3A across time, in accordance with example embodiments of the disclosure.

FIG. 4 illustrates a schematic diagram of example schedule offloading in which a host processor provides schedule data and a processor executes one or more schedules using on-processor orchestration, in accordance with example embodiments of the disclosure.

FIG. 5 illustrates a schematic diagram of example target model parallel verification using a single forward pass and identification of a first disagreement position, in accordance with example embodiments of the disclosure.

FIG. 6 illustrates a flow diagram of an example combined method including schedule offloading, within-layer pipelining, and inter-layer streaming, in accordance with example embodiments of the disclosure.

FIG. 7 illustrates a flow diagram of an example method for non-blocking execution of multiple layers for a batch of samples, in accordance with example embodiments of the disclosure.

FIG. 8 illustrates a flow diagram of an example method for schedule offloading using on-processor orchestration, in accordance with example embodiments of the disclosure.

FIG. 9 illustrates a block diagram of an example reconfigurable data processor comprising an array of configurable units and a configuration load/unload controller, in accordance with example embodiments of the disclosure.

FIG. 10 illustrates a block diagram of an example top-level network interconnecting tiles and address generation and coalescing units of a reconfigurable data processor, in accordance with example embodiments of the disclosure.

FIG. 11A illustrates a schematic diagram of an example tile-level array-level network including switch units, configurable units, and one or more access gateway units, in accordance with example embodiments of the disclosure.

FIG. 11B illustrates a schematic diagram of an example switch unit usable in the array-local network of FIG. 11A, in accordance with example embodiments of the disclosure.

FIG. 12 illustrates a block diagram of an example configurable compute unit including interfaces to scalar, vector, and control buses and a configuration data store, in accordance with example embodiments of the disclosure.

FIG. 13 illustrates a block diagram of an example configurable memory unit including scratchpad memory and instrumentation logic, in accordance with example embodiments of the disclosure.

FIG. 14 illustrates a block diagram of an example compiler stack configured to generate configuration data for a reconfigurable data processor, in accordance with example embodiments of the disclosure.

### DETAILED DESCRIPTION

The following detailed description is directed to example implementations and is not intended to limit the scope of the claims. A person of ordinary skill in the art will recognize that many variations are possible without departing from the spirit and scope of the disclosed subject matter.

Example implementations of this disclosure describe methods, apparatuses, computer-readable media, and system(s) for non-blocking execution of batched sample processing on a processor comprising compute units. In some examples, a processor may be configured to implement a plurality of layers including operators, and samples of a batch may be pipelined across the operators such that different samples concurrently execute on different operators. In some examples, samples may begin execution of a subsequent layer before all samples of the batch have completed a prior layer, thereby reducing synchronization overhead at layer boundaries.

In some examples, a schedule defining a sequence of kernel executions for a batch of samples may be obtained and executed using on-processor orchestration, wherein execution of the schedule repeats without returning control to a host processor between iterations, and wherein outputs of a completed iteration are provided as inputs to a subsequent iteration. In some examples, a plurality of schedules for respective batches may be executed using on-processor orchestration without returning control to the host processor between executions of different schedules. In some examples, the methods and systems described herein may be applied to speculative decoding, wherein a draft model generates candidate tokens that are verified by a target model in a single forward pass, with accepted tokens determined based at least in part on identification of a first disagreement between the draft and target outputs.

Some processor-based workloads process a batch of samples through a plurality of layers, where each layer includes multiple operators that consume intermediate results and produce outputs for subsequent operators and layers. In some systems, execution is organized using batch-wide synchronization points, such as requiring all samples in a batch to complete execution of one operator before any sample begins a next operator and/or requiring all samples to complete a first layer before any sample begins a second layer. These rigid synchronization barriers can cause compute units to remain idle while waiting for completion of the slowest samples or slowest operators, particularly when operator runtimes are imbalanced or when intermediate results for some samples become available earlier than intermediate results for other samples.

Barrier-heavy execution can degrade utilization and increase end-to-end latency because available compute capacity is not used to perform other ready work while the system waits at operator boundaries or layer boundaries. The problem is one of processor execution and scheduling: even when sufficient work exists in the batch, coarse synchronization can prevent concurrent execution of different operators for different samples and can prevent early progression of some samples into later layers. These inefficiencies may be pronounced for smaller models (e.g., draft models in speculative decoding), where per-layer execution times are short and synchronization overhead at kernel and layer boundaries may consume a disproportionate fraction of total execution time. Additionally, host-side overhead associated with launching kernels and managing state between iterations may further reduce effective throughput, particularly when individual iterations complete quickly and control frequently returns to the host processor.

Accordingly, there is a need for execution techniques that improve operation of a processor comprising compute units when executing a plurality of layers for a batch of samples, including by reducing idle time attributable to batch-wide synchronization and by increasing overlap of work across operators and/or across layers.

In some implementations, this need may be addressed by configuring the processor to implement a plurality of layers including at least a first layer and a second layer, wherein the first layer comprises a plurality of operators including at least a first operator and a second operator, and executing the plurality of layers for the batch of samples using overlapped execution. Execution may comprise pipelining samples of the batch across the operators of the first layer such that the first operator executes for a first sample simultaneously with the second operator executing for a second sample. By permitting different operators of the first layer to execute concurrently for different samples, the processor can keep multiple compute units active rather than forcing the batch to advance through operators in lockstep.

Additionally or alternatively, execution may comprise permitting a sample of the batch to begin execution of the second layer before all samples of the batch have completed the first layer. This inter-layer overlap may reduce or eliminate a batch-wide barrier at the layer boundary and enables concurrent execution across layers, such that compute units associated with the second layer can begin useful work for at least some samples earlier rather than waiting for completion of the first layer for all samples.

In some implementations, both forms of overlap are used, such that samples are pipelined across operators within the first layer while at least one sample begins execution of the second layer before all samples complete the first layer. This combination may increase opportunities for overlap across both the operator dimension and the layer dimension, improving steady-state utilization of compute units during execution of the plurality of layers for the batch.

The disclosed execution techniques may provide concrete technical improvements in processor operation. Within-layer pipelining may reduce idle time associated with operator-boundary synchronization by enabling concurrent execution of different operators on different samples. Inter-layer overlap may reduce idle time associated with layer-boundary synchronization by enabling early entry of some samples into subsequent layers. Together, these mechanisms may reduce stalls attributable to batch-wide barriers, improve utilization of compute units, and can reduce end-to-end latency and/or increase throughput for execution of the plurality of layers for the batch of samples.

These improvements relate to the physical operation and utilization of processor hardware, rather than merely organizing abstract computational tasks or scheduling information. By reducing idle cycles attributable to synchronization barriers and enabling overlapped execution across operators and layers, the disclosed techniques may improve how the processor itself functions when executing batched workloads. The improvements may be measurable in terms of reduced idle time for compute units, increased memory bandwidth utilization, decreased end-to-end latency, and increased throughput for token generation or other sample-based workloads. These are not improvements to an abstract algorithm but rather improvements to how a physical processor executes instructions and moves data.

In some implementations, additional improvements for iterative execution patterns are provided using on-processor orchestration. For example, a schedule defining a sequence of kernel executions for a batch of samples may be obtained and executed using on-processor orchestration, wherein execution of the schedule repeats without returning control to a host processor between iterations, and wherein outputs of a completed iteration are provided as inputs to a subsequent iteration. In some implementations, a plurality of schedules for respective batches may be executed using on-processor orchestration without returning control to the host processor between executions of different schedules. By reducing repeated host-to-processor control transfers and synchronization, the processor can sustain execution with fewer interruptions.

The above techniques may be implemented in a variety of architectures consistent with the claims. While examples herein are described in the context of configurable compute units of a reconfigurable dataflow processor, the disclosed techniques are applicable to other compute units including, but not limited to, compute units of a GPU or CPU. In some implementations, the processor comprises a dataflow processor, including a reconfigurable dataflow processor comprising configurable compute units, and operators of a layer are mapped to the configurable compute units. In other implementations, the processor comprises a plurality of interconnected processors, such as graphics processing units, and different operators are executed on different processors. These implementations may still realize overlapped execution by enabling concurrent execution of different operators for different samples and/or by enabling early progression of some samples into subsequent layers.

In one aspect, a method of processing a batch of samples using a processor comprising compute units comprises configuring the processor to implement a plurality of layers including at least a first layer and a second layer, wherein the first layer comprises a plurality of operators including at least a first operator and a second operator, and executing the plurality of layers for the batch using at least one of pipelining samples of the batch across the operators of the first layer such that the first operator executes for a first sample simultaneously with the second operator executing for a second sample, or permitting a sample of the batch to begin execution of the second layer before all samples of the batch have completed the first layer.

In one aspect, a method using a processor comprising compute units comprises configuring the processor to execute one or more kernels, obtaining a schedule defining a sequence of kernel executions for a batch of samples, and executing the schedule using on-processor orchestration, wherein execution of the schedule repeats without returning control to a host processor between iterations.

In one aspect, a system comprises a processor comprising compute units and memory storing configuration data to configure the processor to implement a plurality of layers including at least a first layer and a second layer, wherein the first layer comprises a plurality of operators including at least a first operator and a second operator, and to execute the plurality of layers for a batch of samples using at least one of pipelining samples of the batch across the operators of the first layer or permitting a sample of the batch to begin execution of the second layer before all samples of the batch have completed the first layer.

The following examples illustrate various implementations and use cases enabled by the present disclosure. These examples are provided for illustration and are not intended to limit the scope of the claims. In various implementations, the methods and systems described herein may be applied to different processor architectures, batch sizes, model configurations, and application contexts.

In one implementation, a reconfigurable dataflow processor may be configured to perform batched token generation for a language model. The processor may comprise an array of configurable compute units interconnected by a configurable network. A compiler may generate configuration data that maps a plurality of decoder layers onto the configurable compute units, wherein each decoder layer is implemented as a fused kernel comprising a plurality of operators including attention operations and feed-forward operations.

During execution, the processor may pipeline samples of a batch across the operators of each layer. For example, when processing a batch of input sequences, a first sample may be executing on a feed-forward operator while a second sample is simultaneously executing on an attention operator of the same layer. This pipelining may reduce total execution time compared to approaches where all samples complete a first operator before any sample begins a second operator.

Additionally or alternatively, the processor may transfer results between layers via non-blocking channels such that a sample begins execution of a subsequent layer before all samples of the batch have completed a prior layer. This may eliminate synchronization barriers at layer boundaries and improve utilization of the configurable compute units.

From a technical standpoint, these optimizations may reduce memory bandwidth requirements by enabling weight reuse across samples, decrease latency by overlapping execution across operators and layers, and improve compute unit utilization by maintaining active execution across the pipeline.

In another implementation, a processor may execute multiple iterations of token generation without returning control to a host processor between iterations. A runtime system may obtain a schedule defining a sequence of kernel executions corresponding to a decode iteration for a batch of samples. The schedule may be executed using on-processor orchestration circuitry, wherein execution of the schedule repeats with outputs of a completed iteration provided as inputs to a subsequent iteration until a termination condition is satisfied.

This approach may reduce host overhead that would otherwise be incurred by launching each decode iteration separately. For workloads involving small models where individual decode iterations complete quickly, host launch latency may represent a significant fraction of total execution time. By offloading schedule execution to the processor, this overhead may be eliminated for all but the first and last iterations of a generation sequence.

Schedule offloading may provide a concrete technical improvement in processor utilization and generation latency by reducing the frequency of host-processor communication during iterative execution.

In a further implementation, the methods described herein may be applied to speculative decoding, wherein a smaller draft model generates candidate tokens that are subsequently verified by a larger target model. The draft model may execute multiple iterations to generate a sequence of candidate tokens, with each iteration benefiting from pipelining across operators, non-blocking layer transfers, and schedule offloading as described above.

The target model may then verify all candidate tokens in a single forward pass. Because causal attention permits computation of multiple positions in parallel when prior token values are known, the target model may process all candidate token positions simultaneously to produce target outputs for each position. A comparison operation may identify a first position at which the target output disagrees with the candidate token, and the system may accept the candidate tokens for all positions before the first position and the target output for the first position.

This approach may achieve speedup compared to autoregressive generation using the target model alone. The magnitude of speedup depends on factors including the acceptance rate of candidate tokens, the number of candidate tokens generated per iteration, and the latency ratio between the draft and target models. In implementations where the draft model executes efficiently due to the optimizations described herein, speculative dec7oding may remain beneficial across a wider range of acceptance rates compared to implementations where draft model execution incurs significant overhead.

The reduced synchronization overhead and improved small-model efficiency enabled by pipelining and schedule offloading may improve the viability of speculative decoding by reducing the proportion of total execution time consumed by draft model iterations.

In yet another implementation, the methods described herein may be applied to a system comprising a plurality of interconnected processors, such as graphics processing units connected via high-bandwidth interconnects. Different operators of a layer may be mapped to different processors, with intermediate results transferred between processors via the interconnects.

Samples of a batch may be pipelined across the processors such that a first processor executes a first operator for a first sample simultaneously with a second processor executing a second operator for a second sample. Similarly, non-blocking transfers may permit a sample to begin execution on processors implementing a subsequent layer before all samples have completed execution on processors implementing a prior layer.

This distributed implementation may enable execution of models that exceed the memory capacity of a single processor while still benefiting from the pipelining and non-blocking transfer optimizations. The technical benefits of reduced synchronization overhead and improved pipeline utilization may apply regardless of whether operators are mapped to configurable compute units within a single processor or to discrete processors in an interconnected system. It should be understood that this example, as well as the reconfigurable dataflow unit examples discussed herein, are illustrative and not limiting; other processor architectures and configurations are contemplated and within the scope of this disclosure.

The foregoing examples illustrate several ways in which pipelining across operators, non-blocking inter-layer execution, and schedule offloading may be combined to achieve overlapped execution for batched sample processing. These examples may be mixed and matched; for example, the same deployment can use within-layer pipelining and inter-layer streaming on a reconfigurable dataflow processor, schedule offloading for iterative token generation, and speculative decoding with parallel target model verification. Together, they may support and enable the full scope of the method and system claims, while also providing concrete technical effects useful to improve the functionality of a computer system. These effects include, but are not limited to: (i) improved utilization of compute units by reducing idle time attributable to batch-wide synchronization, (ii) reduced synchronization overhead by eliminating or reducing barriers at operator and layer boundaries, (iii) decreased end-to-end latency by enabling samples to progress through layers independently, (iv) reduced host-processor overhead by offloading schedule orchestration to the processor, (v) improved memory bandwidth utilization through weight reuse across pipelined samples, and (vi) increased throughput for iterative workloads such as autoregressive token generation. These improvements may enable the disclosed systems and methods to achieve a higher fraction of theoretical peak performance compared to barrier-heavy execution approaches.

It should be understood that any description herein of a method performing an action or function, a system performing an action or function, or an apparatus performing an action or function is not intended to limit the disclosure to any particular statutory class. Descriptions of methods, systems, apparatuses, and computer-readable media are interchangeable, and any feature described in connection with one statutory class provides support for the others. For example, a method step described herein also describes a system or apparatus configured to perform that step, and a computer-readable medium storing instructions that, when executed, cause a processor to perform that step. Similarly, a system or apparatus described as configured to perform an action or function also describes a method comprising that action or function and a computer-readable medium storing instructions to perform that action or function.

### Terminology

As used herein, the phrase one of should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms comprising and consisting have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term coupled is used in an operational sense and is not limited to a direct or an indirect coupling. “Coupled to” is generally used in the sense of directly coupled, whereas “coupled with” is generally used in the sense of directly or indirectly coupled. “Coupled” in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term connected is used to indicate a direct connection, such as electrical, optical, electromagnetical, or mechanical, between the things that are connected, without any intervening things or devices.

The term configured (to perform a task or tasks) is a broad recitation of structure generally meaning “having circuitry that” performs the task or tasks during operation. As such, the described item may be configured to perform the task even when the unit/circuit/component is not currently on or active. In general, the circuitry that forms the structure corresponding to “configured to” may include hardware circuits, and may further be controlled by switches, fuses, bond wires, metal masks, firmware, and/or software. Similarly, various items may be described as performing a task or tasks, for convenience in the description. Such descriptions should be interpreted as including the phrase “configured to.” Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. $ 112, paragraph (f) interpretation for that element unless the language “means for” or “step for” is specifically recited.

As used herein, the term based on is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

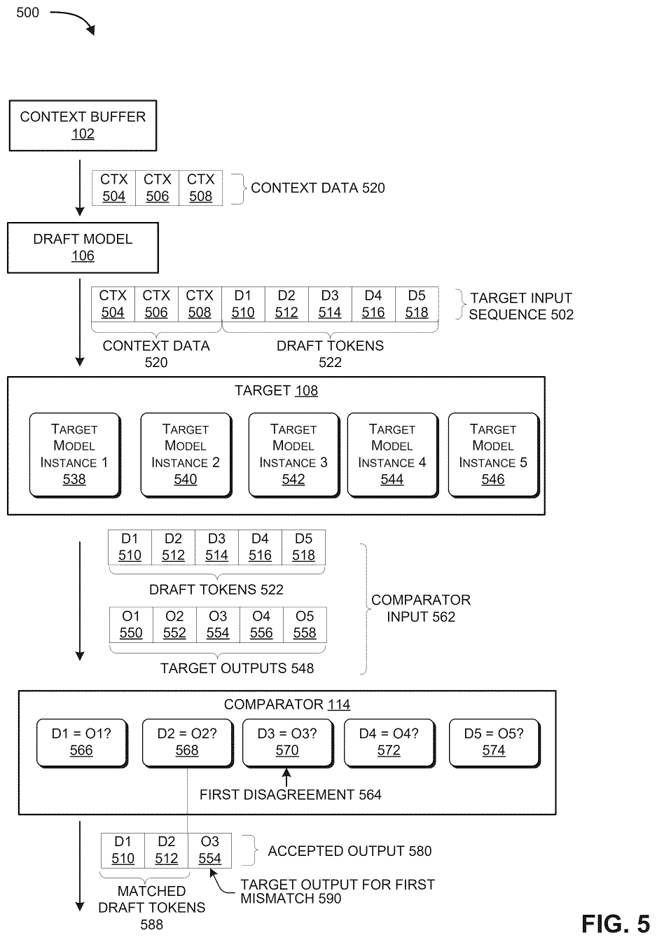

The following terms or acronyms used herein are defined at least in part as follows:
AGCU—address generator (AG) and coalescing unit (CU).
AI—artificial intelligence.
AIR—arithmetic or algebraic intermediate representation.
ALN—array-level network.
Buffer—an intermediate storage of data.
CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.
CGRA—coarse-grained reconfigurable architecture. A data processor architecture that includes one or more arrays (CGR arrays) of CGR units.
Compiler—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 5.
Computation graph—some algorithms may be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions may be executed concurrently.
CGR unit—a circuit that may be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.
CU—coalescing unit.
Dataflow Graph—a computation graph that includes one or more loops that may be nested, and wherein nodes can send messages to nodes in earlier layers to control the dataflow between the layers.
Datapath—a collection of functional units that perform data processing operations. The functional units may include memory, multiplexers, ALUs, SIMDs, multipliers, registers, buses, etc.
FCMU—fused compute and memory unit-a circuit that includes both a memory unit and a compute unit.
Graph—a collection of nodes connected by edges. Nodes may represent various kinds of items or operations, dependent on the type of graph. Edges may represent relationships, directions, dependencies, etc.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
A logical CGR array or logical CGR unit—a CGR array or a CGR unit that is physically realizable, but that may not have been assigned to a physical CGR array or to a physical CGR unit on an IC.
Metapipeline—a subgraph of a computation graph that includes a producer operator providing its output as an input to a consumer operator to form a pipeline. A metapipelines may be nested within another metapipeline, that is, producer operators and consumer operators may include other metapipelines.
ML—machine learning.
PCU—pattern compute unit—a compute unit that may be configured to repetitively perform a sequence of operations.
PEF—processor-executable format—a file format suitable for configuring a configurable data processor.
Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the CGR processor, CGR array level, and/or GCR unit level.
Pipeline Stages—a pipeline is divided into stages that are coupled with one another to form a pipe topology.
PMU—pattern memory unit—a memory unit that can locally store data according to a programmed pattern.
PNR—place and route—the assignment of logical CGR units and associated processing/operations to physical CGR units in an array, and the configuration of communication paths between the physical CGR units.
RAIL—reconfigurable dataflow unit (RDU) abstract intermediate language.
CGR Array—an array of CGR units, coupled with each other through an array-level network (ALN), and coupled with external elements via a top-level network (TLN). A CGR array can physically implement the nodes and edges of a dataflow graph.
SIMD—single-instruction multiple-data—an arithmetic logic unit (ALU) that simultaneously performs a single programmable operation on multiple data elements delivering multiple output results.
TLIR—template library intermediate representation.
TLN—top-level network.

### Implementations

The architecture, configurability and dataflow capabilities of an array of CGR units enable increased compute power that supports both parallel and pipelined computation. A CGR processor, which includes one or more CGR arrays (arrays of CGR units), may be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

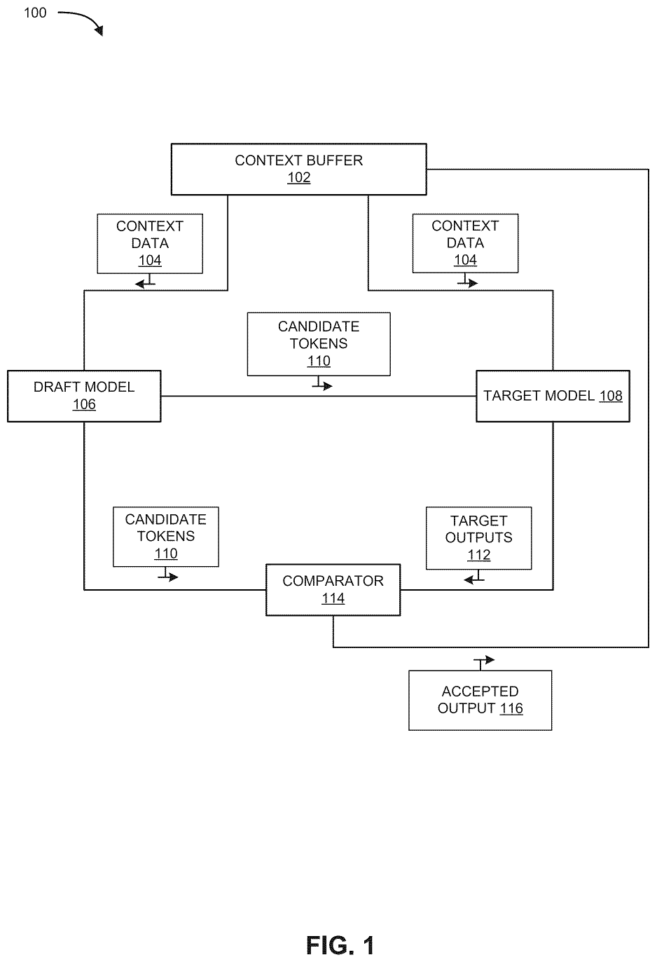

Certain implementations and implementations of the disclosure will now be described more fully below with reference to the accompanying figures, in which various aspects are shown. In particular, the following sections describe an example environment, system components, and processing flows in further detail with reference to FIGS. 1-14. However, the various aspects may be implemented in many different forms and should not be construed as limited to the implementations set forth herein. The disclosure encompasses many different forms and should not be construed as limited to the implementations set forth herein. It will be appreciated that the disclosure encompasses variations of the implementations, as described herein. Like numbers refer to like elements throughout.

FIG. 1 illustrates a block diagram of an example speculative decoding system 100, in accordance with example embodiments of the disclosure. In the example of FIG. 1, the system 100 may include a context buffer 102, a draft model 106, a target model 108, and a comparator 114.

The context buffer 102 may store context data 104 for one or more samples (e.g., sequences of a batch). The draft model 106 may receive the context data 104 and may generate candidate tokens 110. The target model 108 may receive the candidate tokens 110 together with the context data 104 and may generate target outputs 112 corresponding to candidate token positions. The comparator 114 may compare the candidate tokens 110 to the target outputs 112 to form an accepted output 116. In this manner, the system 100 may produce accepted tokens (and/or other accepted results) while reducing latency and/or compute relative to verifying each token individually with the target model.

In some implementations, decoding may proceed in iterations (also referred to herein as steps) in which, for each sample, the draft model 106 may propose a speculation window of up to k candidate tokens (where k is an integer greater than or equal to 1), the target model 108 may verify the proposed positions (e.g., in parallel and/or in a single pass that produces outputs for multiple candidate positions), and the comparator 114 may determine a first disagreement (if any) between the draft proposals and the target outputs. The number of draft tokens accepted for a given sample in a step may be variable (e.g., between 0 and k) and may differ among samples in the batch. In some implementations, an acceptance rate (AR) for a step (or averaged over steps) may be computed as a ratio of accepted draft tokens to proposed draft tokens (e.g., AR=accepted_count/k for a given step or AR=total_accepted/total_proposed over multiple steps), and such acceptance statistics may be used for scheduling, adaptation, and/or performance tracking.

In some implementations, decoding may proceed in iterations (also referred to herein as steps) in which, for each sample, the draft model may propose a speculation window of up to k candidate tokens (where k is an integer greater than or equal to 1), the target model may verify the proposed positions (e.g., in parallel and/or in a single pass that produces outputs for multiple candidate positions), and the comparator may determine a first disagreement (if any) between the draft proposals and the target outputs. The number of draft tokens accepted for a given sample in a step may be variable (e.g., between 0 and k) and may differ among samples in the batch. In some implementations, an acceptance rate (AR) for a step (or averaged over steps) may be computed as a ratio of accepted draft tokens to proposed draft tokens (e.g., AR=accepted_count/k for a given step or AR=total_accepted/total_proposed over multiple steps), and such acceptance statistics may be used for scheduling, adaptation, and/or performance tracking.

The illustrated blocks may represent logical functions and are not limited to any particular physical partitioning or implementation technology. For example, the context buffer 102 may include or be implemented with one or more memories, queues, circular buffers, cache structures, and/or per-sample state stores, and the context data 104 may include any combination of tokens, embeddings, key/value cache entries, attention state, positional state, sequence-length indicators, and/or other decoding state. In some implementations, the per-sample state may include while the figure shows that can (i) a current decode position, (ii) a step counter, (iii) a speculation window length k (which may be fixed or adjustable), (iv) one or more pointers/offsets into key/value caches, (v) a first-mismatch index (or a “no mismatch” indicator), and/or (vi) an accepted-length value indicating how many candidate tokens were accepted in the most recent step. The draft model 106 and target model 108 may be separate models, different parameterizations of a similar architecture (e.g., models sharing a common operator sequence but differing in model size, number of parameters, hidden dimensions, or layer count), different decoding “modes” of a common model, or otherwise related and/or unrelated token generation engines. Likewise, the comparator 114 may be implemented as dedicated hardware, a software routine, a microcode sequence, or a pipeline stage, and may accept/deny candidate tokens based at least in part on equality, probability/logit comparisons, thresholds, rules, or other acceptance policies in addition to (or instead of) strict equality.

Although FIG. 1 shows a single draft model 106 and a single target model 108, other implementations can use multiple draft models, multiple target models, and/or a hierarchical arrangement (e.g., a first draft model proposes a first set of candidates and a second draft model proposes refinements). Further, while the figure shows that candidate tokens 110 and context data 104 may both be provided to the target model 108, implementations may provide the target model with a derived target input sequence, transformed inputs (e.g., packed or padded sequences, ragged representations, or per-sample prefix windows), or other representations that correspond to (or are computed from) the context data 104 and candidate tokens 110. In some implementations, accepted output 116 may include tokens; in other implementations, accepted output 116 additionally or alternatively may include metadata such as an index of the first mismatch, per-sample accepted-length values, acceptance rate statistics (e.g., AR), confidence scores, per-position flags, updated context state to be written back into context buffer 102, and/or host-visible events. In some implementations, accepted output 116 may also include instructions or descriptors for updating decode state (e.g., commit/discard regions in a cache, advance pointers, update sequence length, or re-form a target input sequence for the next step).

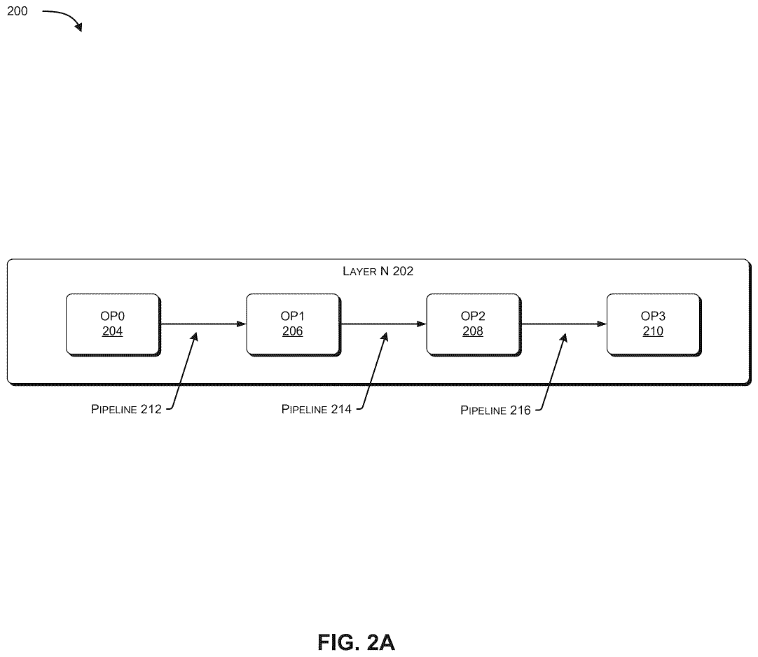

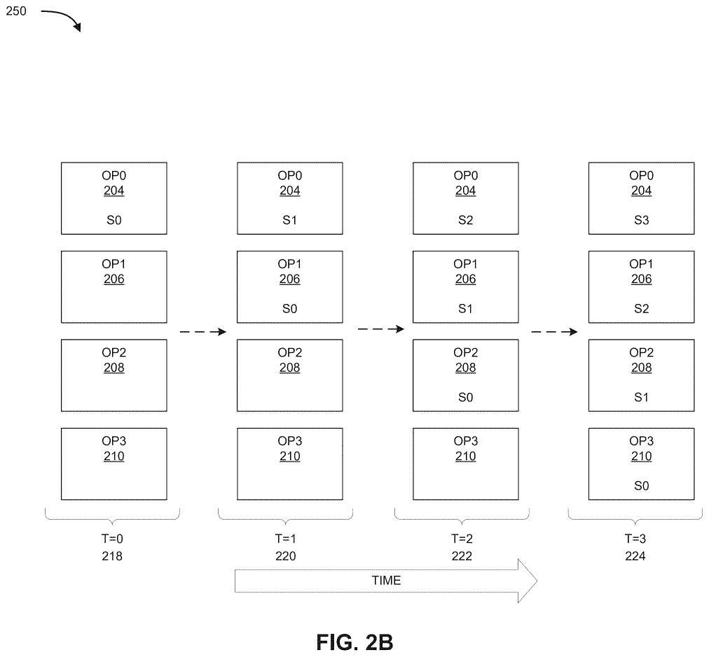

FIG. 2A illustrates a schematic diagram of example within-layer pipelining 200, in accordance with example embodiments of the disclosure. In the example of FIG. 2A, the within-layer pipelining 200 may include a layer N 202 comprising a plurality of operators OP0 204, OP1 206, OP2 208, and OP3 210 coupled by pipelines 212, 214, and 216.

The pipelines 212, 214, and 216 may convey intermediate results between operators such that different samples of a batch may be concurrently processed by different operators of the same layer N 202. This arrangement may reduce bubbles and/or improve utilization by permitting overlapping execution of operator stages for different samples once the pipeline is filled. In some implementations, within-layer pipelining may be used in both the draft phase and the verification phase. Additionally or alternatively, within-layer pipelining may accommodate workloads in which samples have different context lengths or different per-sample execution characteristics (e.g., due to cumulative differences in token acceptance), thereby avoiding a requirement that all samples be aligned to identical execution boundaries at all times.

The term “operator” as used here is not limited to any specific neural network operation, instruction type, or kernel boundary. In some implementations, an operator may correspond to a subgraph of a decode layer (e.g., one or more matrix operations, attention sub-steps, normalization steps, activation steps, residual additions, or memory movement steps). In other implementations, an operator may correspond to a more general compute stage (e.g., a programmable kernel, a hardware pipeline stage, a microprogram loop, or a collection of fused micro-operations). The number of operators in the layer, their internal structure, and the partitioning of a “layer” into operators can vary, and the depicted four-operator example is illustrative rather than limiting. In some implementations, at least one operator may perform cache-related work, such as writing key/value entries, updating cache pointers, compacting or indexing cache structures, copying cache deltas, and/or performing a commit/discard action based on the comparator's accepted-length result.

Within-layer pipelining may be implemented with any form of producer/consumer buffering, including FIFOs, double buffers, scratchpad exchanges, credit-based flow control, and/or backpressure signaling. Intermediate results may include activations, partial reductions, tiles, chunks, streams, or other representations. In some implementations, pipeline transfers (e.g., via pipelines 212/214/216) occur at sub-sample granularity (e.g., per tile or per block) rather than only at full-sample boundaries, enabling an operator to begin processing before a predecessor operator completes the entire sample. In some implementations, within-layer pipelining may overlap compute operators that produce attention/FFN activations with memory-movement or cache-update operators, which may reduce or hide overhead associated with per-token or per-step cache updates. In some examples, within-layer pipelining may enable weight reuse across samples by streaming weights once while multiple samples flow through pipeline stages.

In some examples, within-layer pipelining may enable weight reuse across samples by streaming weights once while multiple samples flow through pipeline stages. In some implementations, weights for one or more layers may be pre-loaded into on-chip memory (e.g., scratchpad memory or PMUs) prior to execution, such that computation proceeds without requiring dynamic weight loading during layer execution. Additionally or alternatively, in implementations where weights for all layers do not fit simultaneously in on-chip memory, weights for a subsequent layer may be loaded into on-chip memory while batch-sample compute is in progress for a current layer, thereby overlapping weight loading with computation.

Additionally or alternatively, while batch-sample compute is in progress for a current layer, weights for a subsequent layer may be loaded into on-chip memory, thereby overlapping weight loading with computation.

FIG. 2B illustrates a schematic diagram of example within-layer pipelining across time, in accordance with example embodiments of the disclosure. As discussed above with regard to FIG. 2A, a timeline diagram 250 corresponding to the within-layer pipelining of FIG. 2A is shown across time steps T=0 218, T=1 220, T=2 222, and T=3 224. The timeline depicts samples (e.g., S0-S3) advancing through the operators over time such that, after an initial fill period, different operators concurrently execute for different samples at a given time step, thereby overlapping execution across operators within the layer. In some implementations, different samples may represent different sequences at different decode positions, and pipeline occupancy may be maintained even when samples have different sequence lengths or different acceptance outcomes during verification.

The timeline is illustrative and is not intended to require discrete “time steps” of a particular duration or synchronization style. For example, time steps can correspond to scheduling quanta, cycles, epochs, kernel intervals, or any other convenient measurement of progression. A sample “Si” can represent an individual sequence, an element of a microbatch, a beam, a hypothesis, or any other unit of work. Additionally, the mapping shown (e.g., one sample per operator slot per time step) is not limiting; implementations can allow an operator to process multiple samples concurrently, can split a sample across lanes, or can allow a sample to occupy multiple operators in parallel depending on data dependencies and available compute resources. In some implementations, the mapping may be policy-driven (e.g., prioritizing samples with available work, prioritizing samples with shorter speculation windows, or prioritizing samples with pending cache-commit work).

Additionally or alternatively, the processor may execute multiple parallel instances of the pipeline, and samples may be dynamically assigned or reassigned among the parallel instances based on execution state. For example, if a first sample experiences delay at a particular operator stage in a first pipeline instance while a second sample queued behind the first sample is ready to proceed, the second sample may be migrated to a corresponding operator stage in a second parallel pipeline instance that has availability, thereby permitting the second sample to proceed without waiting for the first sample to complete. Further, if the first sample remains delayed while operator stages in the first pipeline instance ahead of the delayed first sample become available (e.g., because no samples are feeding those stages), samples from the second pipeline instance may migrate to the available operator stages in the first pipeline instance, thereby utilizing the otherwise idle stages. This bidirectional dynamic migration across parallel pipeline instances may improve throughput by reducing or eliminating stalls attributable to variable per-sample execution times and by maintaining higher utilization of available operator stages across the parallel instances.

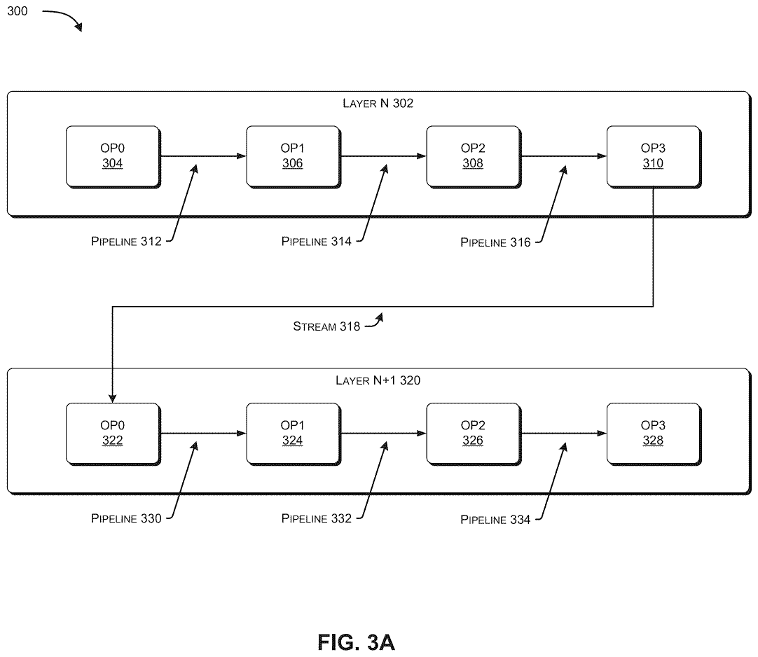

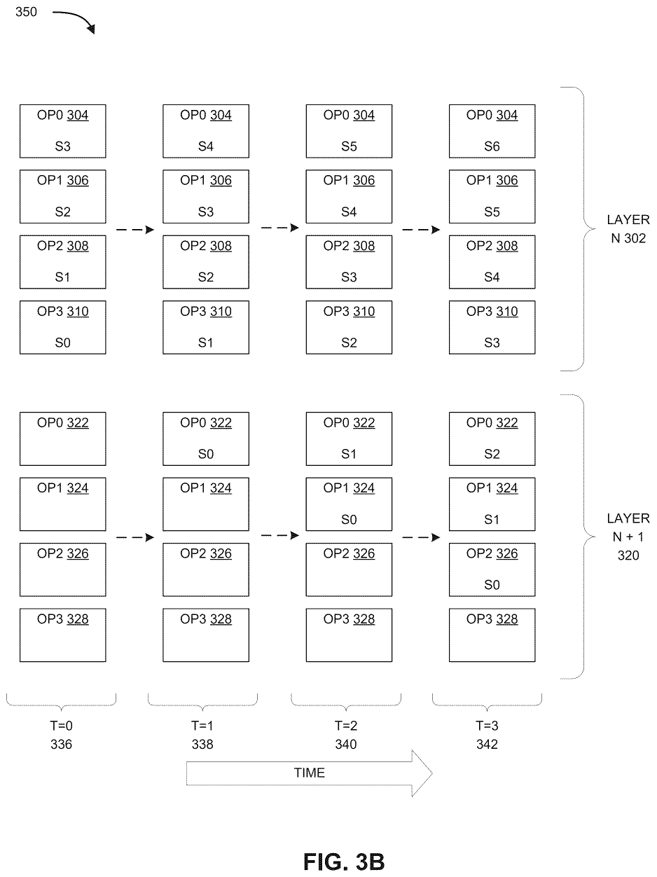

FIG. 3A illustrates a schematic diagram of example inter-layer streaming 300, in accordance with example embodiments of the disclosure. In the example of FIG. 3A, the inter-layer streaming 300 may include a layer N 302, a layer N+1 320, and a stream 318 coupling an output of layer N 302 to an input of layer N+1 320.

The layer N 302 may include operators OP0 304, OP1 306, OP2 308, and OP3 310 coupled by pipelines 312, 314, and 316. The layer N+1 320 may include operators OP0 322, OP1 324, OP2 326, and OP3 328 coupled by pipelines 330, 332, and 334. The stream 318 may couple the layers such that a sample may begin execution in layer N+1 320 after completing at least a portion of layer N 302, without waiting for all samples of the batch to complete layer N 302. In some implementations, inter-layer streaming may be used to reduce or avoid batch-wide stalls that would otherwise occur at layer boundaries when processing a batch of samples. Additionally or alternatively, inter-layer streaming may reduce stalls attributable to variable per-sample execution times, such as when samples have different context lengths (e.g., due to cumulative differences in token acceptance across iterations), which may result in different computation times per sample within a layer.

This inter-layer streaming 300 may be understood as reducing or eliminating a batch-wide barrier at the layer boundary. In some implementations, the stream 318 may be a non-blocking communication channel, queue, or rendezvous buffer that allows work to flow between layers as soon as the intermediate data is available. Additionally or alternatively, inter-layer streaming may accommodate samples with different context lengths or different per-layer execution times by permitting faster-completing samples to proceed without waiting for slower-completing samples. In some implementations, the stream 318 is a non-blocking communication channel, queue, or rendezvous buffer that allows work to flow between layers as soon as the intermediate data is available. For example, stream 318 may carry per-sample intermediate activations, partial results, and/or per-sample state (including updated key/value cache data) from layer N 302 into layer N+1 320. Stream 318 may be implemented using on-chip FIFOs, shared memory queues, hardware streams, DMA-backed buffers, or other mechanisms that support overlap and/or decoupling. In some implementations, cache updates are streamed as (i) full key/value tiles, (ii) deltas to an existing cache region, and/or (iii) commit records indicating which speculative entries are to be retained versus discarded. In some examples, operators of a layer may be fused into a single kernel (e.g., fusing attention and feed-forward operations of a decoder block), and inter-layer streaming 300 may provide a non-blocking boundary between such fused kernels.

Although FIG. 3A depicts corresponding operators between layer N and layer N+1, the correspondence is not required. In some implementations, layer N+1 may include a different number of operators than layer N, uses different operator boundaries, or is executed by different compute elements. Further, while FIG. 3A shows a single stream 318 coupling the layers, other implementations may use multiple streams (e.g., one per operator boundary, one per data type, or one per sample class), and may include arbitration and/or prioritization when multiple samples attempt to progress between layers. In some implementations, samples that have advanced farther (e.g., by accepting more draft tokens) may proceed to subsequent work while other samples remain in earlier work, thereby allowing the batch to be treated as a dynamic membership set rather than a strictly lock-stepped group.

FIG. 3B illustrates a schematic diagram of example inter-layer streaming across time, in accordance with example embodiments of the disclosure. As discussed above with regard to FIG. 3A, a timeline diagram 350 corresponding to the inter-layer streaming of FIG. 3A is shown across time steps T=0 336, T=1 338, T=2 340, and T=3 342. The timeline shows overlapped execution across layers in which, at a given time step, at least one sample is executing within layer N+1 320 while one or more other samples are still executing within layer N 302, demonstrating that layer-to-layer progression for a given sample may occur without a batch-wide barrier at the layer boundary. In some implementations, the illustrated overlap applies to both draft generation and target verification, including in cases where the target verification consumes a derived target input sequence that includes context tokens and draft tokens for multiple candidate positions.

As with FIG. 2B, the depicted scheduling is illustrative. In some implementations, overlap may be partial (e.g., only certain operators of layer N+1 begin early), and/or overlap is opportunistic based on resource availability, buffer levels, or policy. In some implementations, a sample may progress to the next layer after completing a predefined portion of the preceding layer, after producing a particular intermediate tensor, after satisfying a readiness predicate, or after passing a correctness/consistency check. In other implementations, progression may depend on availability of memory bandwidth, availability of compute lanes, or a run-time scheduler that attempts to keep pipelines occupied. In some implementations, the scheduler may account for per-sample accepted-length and/or mismatch position such that cache-commit work and next-step preparation work for a sample can begin without waiting for other samples.

Additionally or alternatively, execution may be non-blocking at schedule boundaries such that a sample that completes execution of a schedule and has not satisfied a termination condition (e.g., has not generated an end-of-sequence token) may immediately begin a subsequent iteration of the schedule without waiting for other samples of the batch to complete their current schedule iteration. In such implementations, outputs of the completed iteration for the sample (e.g., generated tokens, updated context, cache state) are provided as inputs to the subsequent iteration for that sample, and the sample re-enters the schedule while other samples continue executing within their respective iterations. This per-sample non-blocking schedule re-entry may be used in combination with the parallel pipeline instances described above, such that a sample completing a schedule iteration may re-enter the schedule via whichever parallel pipeline instance has availability at the first operator stage, or may be used independently of parallel pipeline instances. This approach may reduce idle time and improve throughput by permitting samples to progress independently through successive schedule iterations.

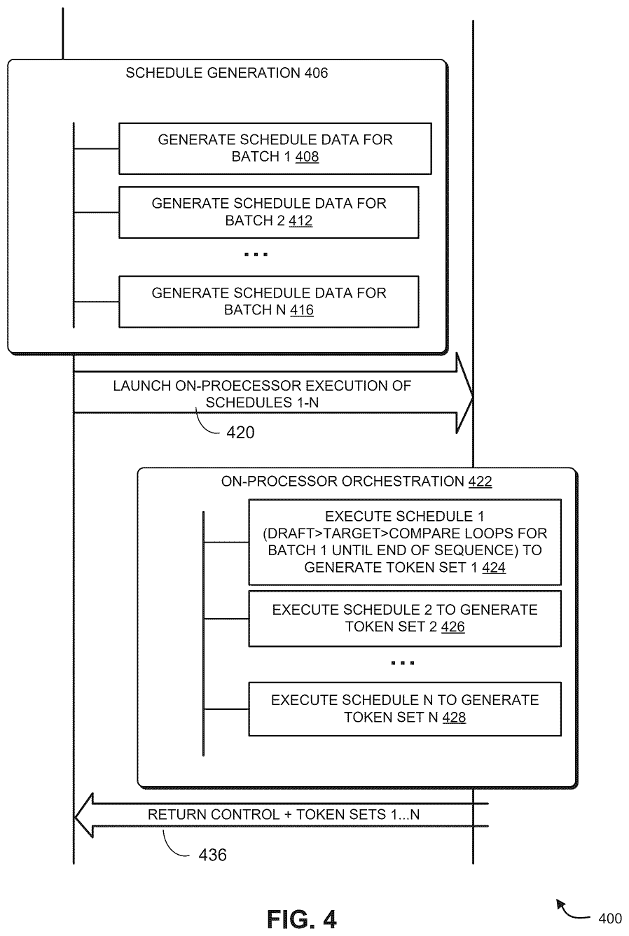

FIG. 4 illustrates a schematic diagram of example schedule offloading execution 400, in accordance with example embodiments of the disclosure. In the example of FIG. 4, the schedule offloading execution 400 may include schedule generation 406, on-processor orchestration 422, and Token Sets 1-N (424, 426, 428).

The schedule generation 406 may generate schedule data for Batch 1 408, Batch 2 412, and Batch N 416, and may launch on-processor execution of schedules 1-N 420. The on-processor orchestration 422 may execute the schedules and may produce Token Sets 1-N (424, 426, 428) that may be returned (with control) as Token Sets 1 . . . N 436. Each schedule may define a sequence of kernel executions for a respective batch and may repeat (e.g., looping through “DRAFT>TARGET>COMPARE” operations) until a termination condition such as an end-of-sequence condition is satisfied, but the schedule-offload concept is not limited to end-of-sequence termination and may support other termination policies. A plurality of schedules for respective batches may be executed using on-processor orchestration without returning control to a host processor between executions of different schedules. In some implementations, schedule offloading may be used to keep the device in a steady-state decode loop even when samples diverge (e.g., accept different numbers of tokens), by allowing per-sample control flow and per-sample state advancement to be handled on-device.

In implementations, the schedule data can define (i) a sequence of kernel executions, (ii) dependencies between kernels, (iii) buffer bindings and memory regions, (iv) control-flow elements (including loops and conditional branches), and/or (v) resource mappings. In some implementations, schedule generation 406 may be performed by a compiler, a runtime system, a host library, or a combination thereof. For example, schedule generation can produce a schedule that repeatedly executes a decode-layer pipeline, updates per-sample state (e.g., context and caches), and emits generated tokens. This may reduce repeated host-side kernel-launch overhead and/or repeated host intervention that would otherwise occur between iterations. In some implementations, a schedule may include explicit kernels for (a) writing tentative key/value entries for candidate positions, (b) comparing draft candidates to target outputs, and (c) committing/discarding cache entries based on a first-mismatch result and an accepted-length value for each sample.

The illustrated on-processor orchestration 422 may be implemented as a hardware scheduler, a microcontroller, a firmware routine, a runtime kernel, or other on-device control logic. The orchestration can manage multiple concurrently active schedules and may include fairness, priority, and/or QoS policies when multiple batches compete for shared resources. The “Token Set” returned for a schedule (e.g., Token Set 1 424, Token Set 2 426, Token Set N 428) may include, for each sample in the corresponding batch, per-sample results comprising one or more of: newly generated tokens, accepted tokens, a count of accepted tokens, per-token metadata, a mismatch position, updated per-sample state (e.g., key/value cache pointers, commit/discard metadata, decode position), and/or host-visible events.

Further, although FIG. 4 depicts schedule generation occurring before schedule launch, implementations can generate schedules incrementally (e.g., streaming schedule fragments), can adapt schedules based on observed acceptance rates, buffer occupancy, or performance counters, and can halt/resume schedules based on host requests or on-device conditions. In some implementations, the on-processor orchestration may perform compatibility checks between consecutive schedule fragments or schedule instances (e.g., verifying that an output tensor's datatype/shape/size matches a subsequent input expectation) and may perform patching of addresses/pointers/offsets (e.g., binding the next schedule's inputs to the prior schedule's outputs, updating per-sample base pointers into caches, and/or updating stride/shape descriptors) to enable seamless schedule chaining without host involvement.

FIG. 5 illustrates a schematic diagram of example target model parallel verification 500, in accordance with example embodiments of the disclosure. In the example of FIG. 5, the parallel verification 500 may include a context buffer 102, a draft model 106, a target model 108, a comparator 114, a target input sequence 502, and a plurality of target model instances (538, 540, 542, 544, 546).

The context buffer 102 may store and provide context data 520 representing the current conversation or prompt state. The draft model 106 may generate draft tokens 522 including draft tokens D1-D5 (510, 512, 514, 516, 518). A target input sequence 502 may be assembled from context tokens (CTX 504, 506, 508) concatenated with the draft tokens D1-D5. The target model 108 may process the target input sequence 502 using parallel verification, wherein the target model instances (instance 1 538, instance 2 540, instance 3 542, instance 4 544, instance 5 546) may each compute a next-token prediction for a respective position in the sequence. The target model instances may produce target outputs 548 comprising output tokens O1-O5 (550, 552, 554, 556, 558), where each output Oi may represent the target model's prediction given the prefix through position i−1.

The comparator 114 may receive a comparator input 562 comprising the draft tokens 522 and the target outputs 548. The comparator 114 may perform element-wise comparisons D1=O1? (566), D2=O2? (568), D3=O3? (570), D4=O4? (572), and D5=O5? (574) to identify a first disagreement 564, which may be the earliest position where the draft token does not match the target output. The comparator 114 may produce an accepted output 580 that may include matched draft tokens 588 (the draft tokens up to but not including the first mismatch) and a target output for first mismatch 590 (the target model's correction token at the disagreement position). In some implementations, D1-D5 may correspond to a speculation window of length k for a given step, and the comparator may yield an accepted-length value a (0≤a≤k) indicating how many draft tokens are accepted for that sample for the step.

The depiction of multiple “target model instances” is illustrative of parallel verification and is not limited to physically distinct copies of a model. In some implementations, the target outputs for multiple draft-token positions may be computed in parallel by vectorizing computation within a single model instance, by distributing work across multiple compute cores or tiles, by issuing multiple concurrent kernel invocations, and/or by pipelining multiple verification positions through a compute fabric. The “instances” may share weights, cache resources, or memory bandwidth, and may be time-multiplexed or spatially partitioned. Likewise, a “draft token” may refer to an actual token ID, a token distribution sample, a candidate from a beam, or another discrete proposal, and a “target output” may refer to a token ID, an argmax token, a sampled token, a top-k set, a probability/logit vector, or other output representation. In batched implementations, different samples may have different mismatch positions and thus different accepted-length values for a given step, and the device may track such per-sample results without forcing all samples to accept only a minimum common prefix.

The acceptance logic is likewise not limited to strict equality checks. For example, in some implementations a draft token may be accepted if it matches the target model's argmax token; in other implementations it may be accepted if it is within a top-k set, above a probability threshold, consistent with a constraint grammar, or otherwise satisfies an acceptance criterion. In some implementations, the “first disagreement” may be defined by a mismatch, by a failure of a confidence threshold, by a divergence in a constrained decoding rule, or by a resource-related condition (e.g., buffer pressure) that triggers early termination of the candidate window. The accepted output 580 may include (i) a variable-length prefix of accepted draft tokens and (ii) a replacement token from the target model at the mismatch position, as illustrated, but may additionally or alternatively include a length indicator, an offset into the draft window, and/or a specification of which draft tokens were discarded. In some implementations, the comparator may additionally output (or trigger) a cache update directive indicating which tentative cache entries corresponding to the candidate window are to be committed versus discarded.

In some implementations, key/value cache handling may be performed as follows. During draft generation for a speculation window, tentative key/value entries for candidate positions may be written into a cache region associated with the sample (e.g., appended into a per-sample cache with a write pointer, written into a staging region, and/or written into a shadow buffer). After verification, for each sample, cache entries corresponding to accepted positions may be committed (e.g., retained in place, copied from staging into a committed region, and/or marked valid), and cache entries corresponding to unaccepted positions (e.g., after the first mismatch) may be discarded (e.g., invalidated, overwritten, or rolled back by resetting a write pointer). In some implementations, commit/discard may be performed using metadata (e.g., validity bitmaps, per-position tags, version counters, or per-sample pointer updates) rather than copying full cache contents. In some implementations, cache update work (including pointer updates and/or metadata updates) may be overlapped with compute via pipelining and/or executed as memory-movement kernels under schedule control.

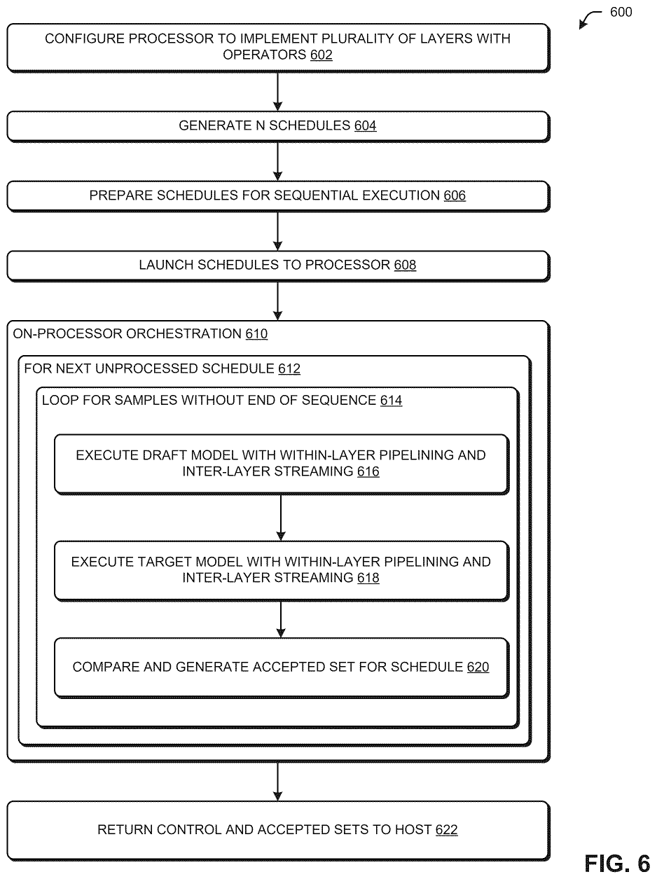

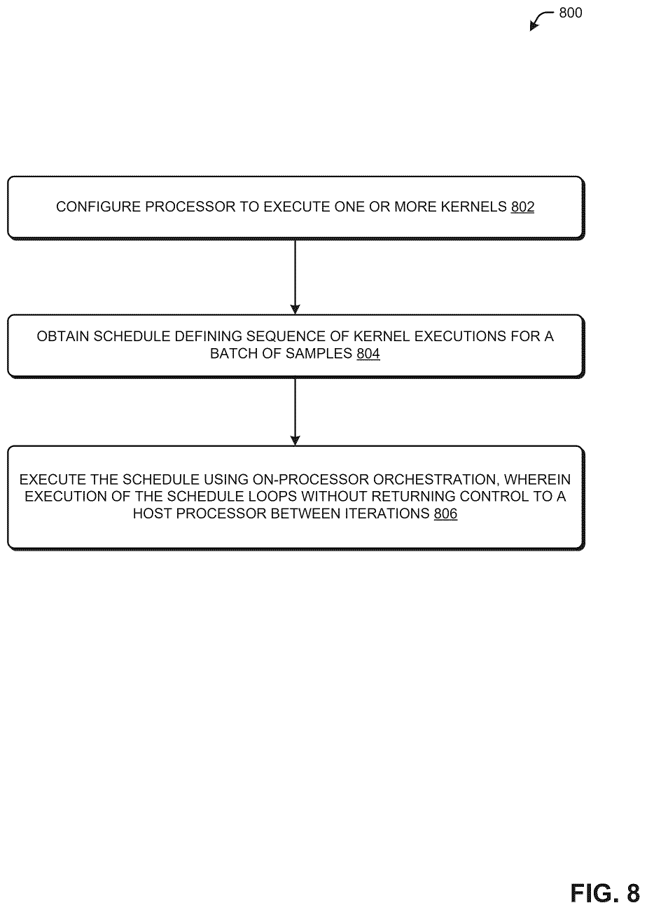

FIG. 6 illustrates a flow diagram of an example method 600, in accordance with example embodiments of the disclosure. Additional details regarding within-layer pipelining and inter-layer streaming are provided above with respect to FIGS. 2A-3B, and additional details regarding schedule offloading and on-processor orchestration are provided below with respect to FIG. 8.

At 602, a processor(s) may be configured to implement a plurality of layers with operator(s). In some examples, configuration may include, but is not limited to, loading configuration data that defines operator boundaries, data movement, buffer binding(s), and/or mapping(s) of operator(s) onto compute resource(s).

At 604, N schedule(s) may be generated. In some examples, each schedule may correspond to a batch, a portion of a batch, a decoding phase, a verification phase, a policy variant, and/or combinations thereof.

At 606, schedule(s) may be prepared for sequential execution. In some examples, preparation may include verifying compatibility between schedules (e.g., data types and buffer sizes), patching addresses such that output of one schedule iteration is compatible with input of a next iteration, and/or binding memory regions. In some implementations, the schedule(s) may be obtained from a processor-executable format (PEF) file or other configuration artifact produced by a compiler. The PEF may include (i) a plurality of kernel bitfiles, wherein each kernel bitfile corresponds to a schedulable unit of work (e.g., a fused subgraph of operations in a model), (ii) one or more schedules, wherein each schedule defines a sequence of kernel executions that invoke one or more of the kernel bitfiles, and (iii) tensor memory allocations specifying memory regions for inputs, outputs, weights, and/or intermediate results associated with the model. In some examples, a kernel may repeat with different inputs within the same schedule, and different schedules may invoke overlapping or distinct subsets of the kernel bitfiles. Preparation may further include a runtime system reading the schedule(s) and kernel bitfile(s) from the PEF and determining an execution sequence for loading and executing the kernel bitfiles on the processor(s).

At 608, the schedule(s) may be launched to the processor(s). In some examples, launch may include transferring schedule data to device-accessible memory and triggering on-device execution without requiring per-iteration host intervention. As illustrated, the schedule(s) may be launched into on-processor orchestration 610 for execution. In some examples, the on-processor orchestration may be implemented in hardware, firmware, microcode, software, and/or combinations thereof.

In on-processor orchestration, at 612, the orchestration may select a next unprocessed schedule for execution. If an unprocessed schedule remains, the process may continue to 614. Otherwise, the process may continue to 622.

In some implementations, upon selecting a schedule at 612, the on-processor orchestration (or a cooperating runtime component) may read the selected schedule from the PEF and may stitch together the kernel bitfile loads specified by the schedule such that the sequence of kernels executes in a hardware-orchestrated manner without per-kernel host intervention. For example, if a schedule specifies a sequence of nine kernel calls referencing five distinct kernel bitfiles (e.g., K0, K1, K2, K3, K4), the orchestration may load and execute the kernel bitfiles in the order specified by the schedule (e.g., K0→K1→K3→K1→K3→K4→K2→K3→K4), reusing previously loaded bitfiles where the schedule indicates repeated invocations. The orchestration may patch buffer addresses and bindings between kernel invocations such that outputs of a preceding kernel are available as inputs to a subsequent kernel without requiring host-side coordination.

At 614, the orchestration may loop execution of a currently selected schedule for sample(s) of the batch of samples corresponding to the currently selected schedule that have not reached an end-of-sequence condition. If at least one sample has not satisfied a termination condition, the process may continue to 616. Otherwise, the process may continue to 612 for selection of another schedule.

At 616, the processor(s) may execute a draft model using within-layer pipelining and/or inter-layer streaming. For example, draft-model operator(s) may be scheduled such that different sample(s) concurrently execute on different operator(s) within a layer, as discussed above with regard to FIGS. 2A-2B, and/or such that a sample begins a subsequent layer before all sample(s) complete a prior layer, as discussed above with regard to FIGS. 3A-3B.

At 618, the processor(s) may execute a target model using within-layer pipelining and/or inter-layer streaming. In some examples, pipelining/streaming may be applied to the target model similarly to the draft model, and/or selectively applied based at least in part on resource utilization, correctness constraint(s), and/or workload characteristic(s).

At 620, the processor(s) may compare draft result(s) and target result(s) and generate an accepted set for the schedule. In some examples, the accepted set may include accepted token(s), rejection indicator(s), mismatch position(s), updated context, updated cache state, and/or other metadata. The process may then return to 614. As mentioned above, if at least one sample has not satisfied a termination condition, the process may repeat 616-620. Otherwise, the process may continue to 612 for selection of another schedule as discussed above.

At 622, control and accepted set(s) may be returned to a host processor(s). In some implementations, when multiple schedules have been executed, the returned results may include a collection of per-schedule results, and each per-schedule result may include a collection of per-sample results for the samples in the corresponding batch. Each per-sample result may include one or more of: accepted token(s), a count of accepted tokens, a mismatch position, updated key/value cache pointer(s), commit/discard metadata, and/or updated decode state. In some examples, returning may include DMA transfer(s), completion event(s), and/or other host-visible notification(s).

On-processor orchestration of schedules may take a variety of forms, including executing a sequence of kernel-execution descriptors, interpreting a composite schedule data structure, or interpreting a schedule-of-schedules. In some implementations, a schedule repeats for decode iterations without returning to the host between iterations, thereby reducing host overhead and enabling the device to maintain steady-state pipeline occupancy. In some implementations, a plurality of schedules correspond to different batches, different model phases (e.g., draft and verify), different sampling policies, or different workload classes, and on-processor orchestration 610 may switch among schedules based at least in part on policy, completion, backpressure, or priority without returning control to the host processor between executions of different schedules. In some implementations, on-processor orchestration may include compatibility verification and runtime patching/binding such that outputs of a completed iteration (e.g., generated tokens, updated context, cache state) may become inputs to a subsequent iteration without host intervention, including updating per-sample cache pointers, per-sample token offsets, and/or base addresses used by subsequent kernel descriptors.

While FIG. 6 depicts both within-layer pipelining and inter-layer streaming for both draft and target model execution, implementations may apply these techniques selectively. For example, within-layer pipelining may be applied to the draft model only, to the target model only, or to both, depending on which phase benefits more from operator overlap. Likewise, inter-layer streaming may be enabled for selected layers, selected samples, or selected schedule iterations, and may be disabled or throttled based at least in part on resource utilization or correctness constraints. In some implementations, the speculation window length k and/or the effective batch membership may be dynamically adjusted based at least in part on observed acceptance rate (AR), observed draft/target latency ratio, cache-update overhead, buffer occupancy/pressure, and/or throughput objectives. For example, when batch size increases or when cache-update overhead increases, k may be reduced to limit wasted tentative work, and when AR is high and resources permit, k may be increased to reduce the number of verification steps.

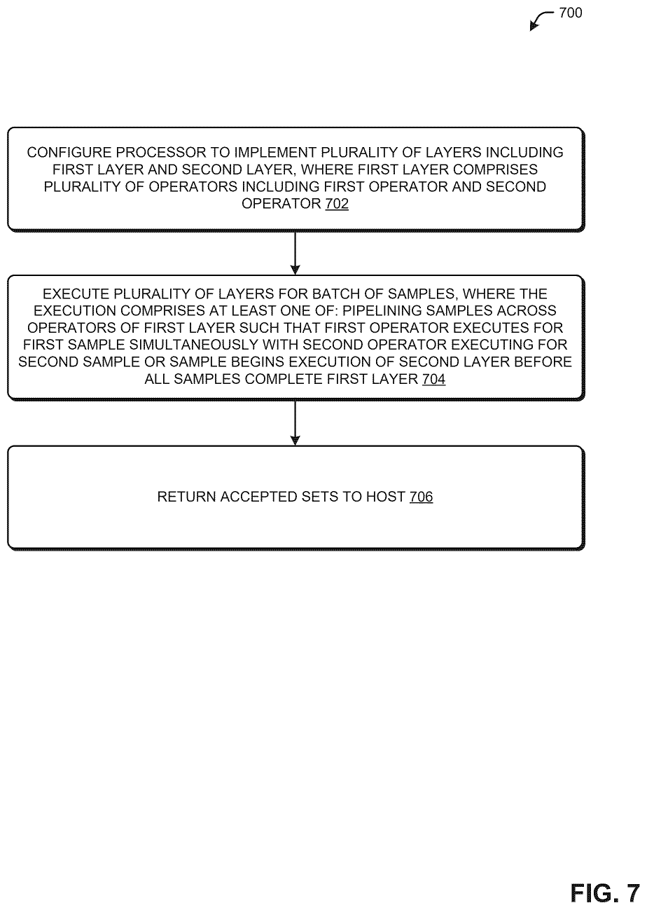

FIG. 7 illustrates a flow diagram of an example method 700, in accordance with example embodiments of the disclosure.

At 702, a processor(s) may be configured to implement a plurality of layers including a first layer and a second layer, where the first layer includes a plurality of operator(s) including a first operator and a second operator.

At 704, the plurality of layers may be executed for a batch of sample(s). In some examples, execution may include at least one of: (i) within-layer pipelining in which the first operator executes for a first sample simultaneously with the second operator executing for a second sample, as discussed above with regard to FIGS. 2A-2B, and/or (ii) inter-layer streaming in which a sample begins execution of the second layer before all sample(s) complete the first layer, as discussed above with regard to FIGS. 3A-3B.

At 706, accepted set(s) may be returned to a host processor(s). In some examples, accepted set(s) may be per-sample and may include accepted token(s) and/or metadata, including, but not limited to, updated decode state, acceptance statistic(s), and/or event(s).

This method emphasizes that batching need not impose an artificial synchronization barrier at each layer boundary. In some implementations, samples in the same batch may proceed through a compute pipeline asynchronously, and different samples may be at different layer indices and/or different operator stages at a given time. The “accepted sets” returned may be per-sample token outputs, per-sample acceptance metadata, per-sample updated decode state (including key/value cache pointer updates and/or commit/discard metadata), or other results of speculative decoding and verification. Further, “non-blocking” may be realized by use of streams/queues, by absence of global barriers, by local readiness signaling, or by a scheduler that opportunistically advances whichever samples are ready for a next operation.

FIG. 8 illustrates a flow diagram of an example method 800 for schedule offloading using on-processor orchestration, in accordance with example embodiments of the disclosure.

At 802, a processor(s) may be configured to execute one or more kernel(s). In some examples, the kernel(s) may include compute kernel(s), memory movement kernel(s), synchronization kernel(s), mixed-function kernel(s), and/or combinations thereof, and may be implemented in hardware, firmware, microcode, software, and/or combinations thereof.

At 804, a schedule defining a sequence of kernel execution(s) for a batch of sample(s) may be obtained. In some examples, the schedule may be provided by a compiler output, a runtime system, a host library, and/or combinations thereof, and may include fixed sequences, conditional branches, adjustable loop bounds, adjustable speculation window length, adjustable batch membership, and/or other dynamically adjustable element(s).

At 806, the schedule may be executed using on-processor orchestration. In some examples, execution may loop without returning control to a host processor between iterations. In some examples, the on-processor orchestration may monitor termination condition(s) and/or buffer state(s) and may end, pause, or adjust the loop accordingly, including excluding sample(s) that have satisfied a termination condition while continuing to process remaining sample(s).

Without schedule offloading, a decode loop may transfer control to a host processor after generating each token, requiring the host to re-launch the decode schedule for each subsequent token. This repeated host intervention may add latency and negate benefits of the dataflow architecture. With schedule offloading, the on-processor orchestration may execute the decode schedule for M iterations (generating M tokens) without returning control to the host between iterations, thereby reducing host overhead and increasing token generation throughput.

It should be noted that some of the operations of methods 600-800 may be performed out of the order presented, with additional elements, and/or without some elements. Some of the operations of methods 600-800 may further take place substantially concurrently and, therefore, may conclude in an order different from the order of operations shown above.

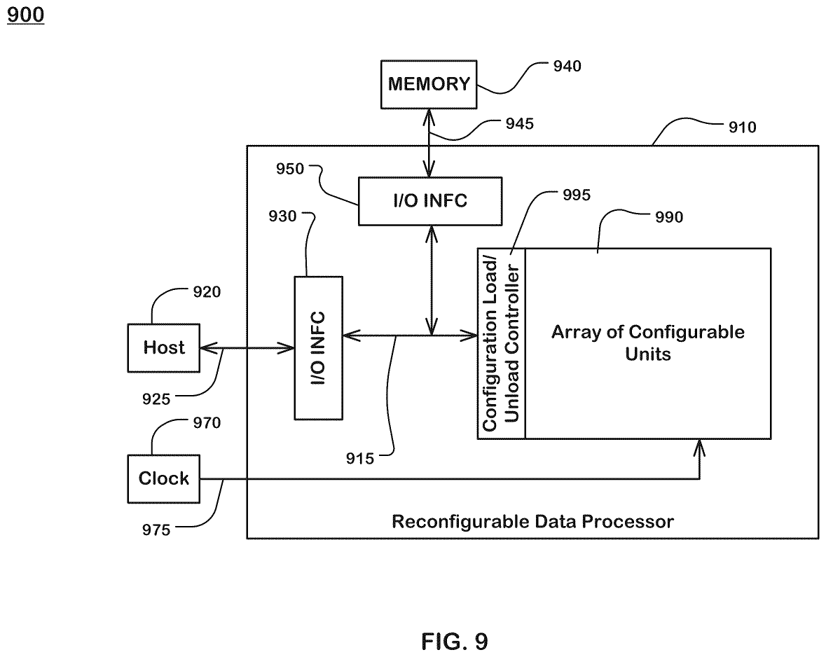

FIG. 9 illustrates a block diagram of an example reconfigurable data processor 900, in accordance with example embodiments of the disclosure. In the example of FIG. 9, the reconfigurable data processor 900 may include a host 920, a host I/O interface 930, memory 940, an external memory I/O interface 950, an internal bus system 915, an array 990 of configurable units, and a configuration load/unload controller 995.

The reconfigurable data processor 900 may be coupled to the host 920 via the host I/O interface 930, and may be coupled to the memory 940 via the external memory I/O interface 950. The external I/O interfaces 930, 950 may communicate with the internal bus system 915 that may provide access to the array 990 of configurable units and to the configuration load/unload controller 995.

In some implementations, the reconfigurable data processor 900 may execute one or more workloads (e.g., neural network layers, draft-model decoding, target-model verification, and/or comparison operations) using configuration data loaded into the array 990 of configurable units. The configuration load/unload controller 995 may read a configuration file from memory 940 and may distribute configuration data to the configurable units of the array 990. For example, the configuration file may include a plurality of unit files (or sub-files), each unit file corresponding to a particular configurable unit and including a plurality of chunks of configuration data; in one example, a chunk may have a width matching a bus width of the internal bus system 915 (e.g., N bits, such as N=128 bits), allowing transfer of one chunk per bus cycle.

In some implementations, each configurable unit may include a configuration store (e.g., registers, flip-flops, or other storage) that represents a setup and/or a sequence to run a program and may include, for example, nested-loop parameters, instructions to be executed, operand sources, and network parameters for input/output interfaces. A configuration file may include a bit-stream representing the initial configuration (starting state) of components that execute the program (e.g., a “bit-file”), and program load may include setting up the configuration stores based at least in part on the bit-file (and, in some implementations, loading PMU memories).

In some implementations, configuration load/unload controller 995 also supports unloading configuration and/or state data from configurable units to memory 940. Reconfigurable data processor 900 may be clocked by a clock 970 (e.g., via connection 975) and may optionally include or couple to additional resources such as power management, monitoring logic, and/or inter-processor interfaces.

In some implementations, the reconfigurable data processor 900 may include multiple tiers of memory, such as (i) on-chip SRAM (e.g., scratchpad memory distributed across configurable units), (ii) on-package high-bandwidth memory (HBM), and (iii) off-package DDR memory. The multiple memory tiers may enable hosting of model parameters across the memory hierarchy, with frequently accessed weights and activations resident in faster tiers and less frequently accessed parameters swappable from slower tiers. For example, weights for a current layer may be pre-loaded into on-chip SRAM while weights for subsequent layers reside in HBM or DDR until needed.

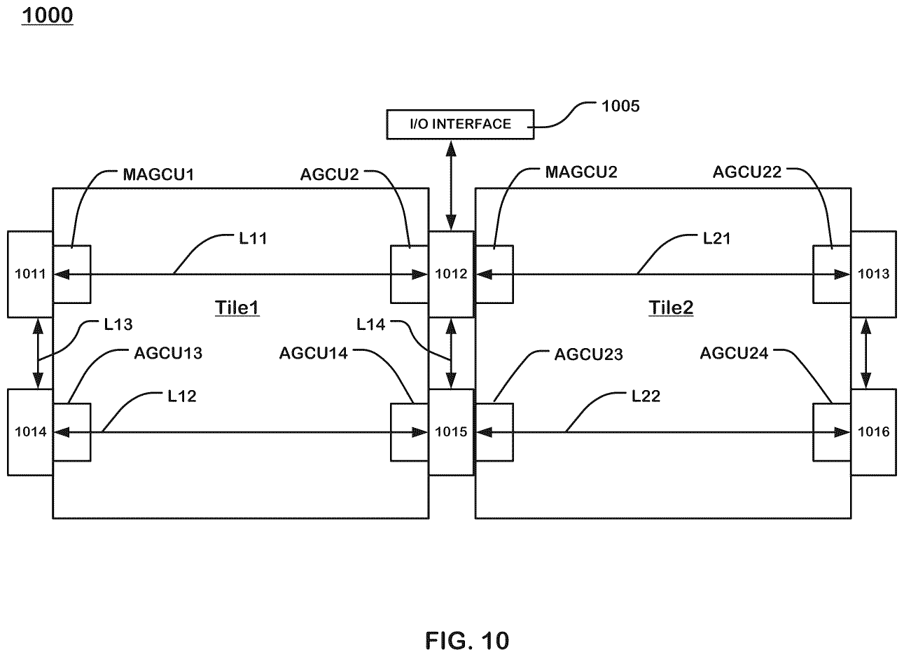

FIG. 10 is a block diagram illustrating an example top-level network 1000 interconnecting tiles and access gateway units of a reconfigurable data processor, in accordance with example embodiments of the disclosure. In the example of FIG. 10, the top-level network 1000 may include switch units 1011, 1012, 1013, 1014, 1015, and 1016 interconnected via links (e.g., L11, L12, L13, L14, L21, L22), a first tile (Tile1), a second tile (Tile2), and an I/O interface 1005.

The switch units 1013, 1014, and 1015 may provide intermediate routing between the tile-edge switch units and may couple to additional access gateway units or inter-tile links. Tile1 may be connected to Tile2 via switch units 1011-1016 and interconnect links (e.g., L11, L12, L13, L14, L21, and L22). Tile1 may include access gateway units such as MAGCU1, AGCU2, AGCU13, and AGCU14, and Tile2 may include access gateway units such as MAGCU2, AGCU22, AGCU23, and AGCU24. The I/O interface 1005 may couple to a switch unit (e.g., switch unit 1012) to provide connectivity between the tile-level network and external interfaces (e.g., a host interface and/or memory interface).

In some implementations, the AGCUs may operate as nodes on the top-level network 1000 and may include resources for routing data among (i) nodes on the top-level network, (ii) nodes on an array-local network within a tile (e.g., an ALN), and (iii) external devices coupled to the I/O interface 1005. In some implementations, one AGCU in a tile may be configured as a master AGCU (MAGCU) that may include an array configuration load/unload controller for the tile and may control operations of an array of configurable units in the tile. In some implementations, the top-level network may include one or more channels such as data, request, and response channels operable in coordination for transfer of data (e.g., analogous to an AXI-compatible protocol).

In some implementations, an AGCU (e.g., a master AGCU) may include hardware graph orchestration logic configured to execute a schedule of kernel launches without host involvement, enabling the processor to autonomously sequence through kernel invocations according to the schedule.

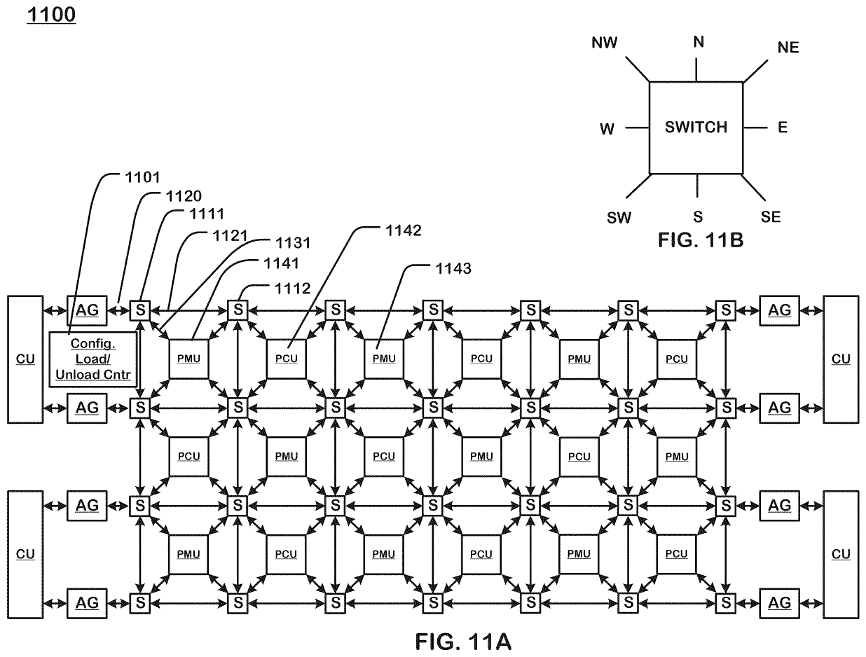

FIG. 11A illustrates a diagram of an example tile-level array-level network (ALN) 1100, in accordance with example embodiments of the disclosure. In the example of FIG. 11A, the ALN 1100 may include configurable units (e.g., CU 1111, CU 1112), pattern compute units (PCUs), pattern memory units (PMUs), switch units(S), access gateway units (AG), coalescing units (CU), and a configuration load/unload controller 1101.

The ALN 1100 may provide on-tile communication among the configurable units, which may be coupled via a switch fabric of switch units(S). The array of configurable units 1100 may include configurable unit instances (e.g., CU 1111, CU 1112) arranged in a two-dimensional grid. Each configurable unit may contain a configuration store comprising a set of registers or flip-flops that may represent either the setup or the sequence to run a program, and may include the number of nested loops, the limits of each loop iterator, the instructions to be executed for each stage, the source of the operands, and the network parameters for the input and output interfaces.

Access gateway units (AG) and coalescing units (CU) may provide connectivity between the tile-level ALN and other components (e.g., other tiles and/or off-chip memory interfaces). The configuration load/unload controller 1101 may be configured to load and/or unload configuration data for the tile and/or for individual configurable units. An array section 1120, 1121 may include additional logic for coordinating access among the configurable units.

As used herein, the phrase “configuration load/unload controller” may refer to a combination of a configuration load controller and a configuration unload controller; in some implementations, load and unload may be implemented using separate logic and datapath resources, and in other implementations the load and unload functions may share logic and/or datapath resources.

The ALN may include links interconnecting configurable units in the array. The links in the ALN may include one or more physical buses: a chunk-level vector bus (e.g., 128 bits of data), a word-level scalar bus (e.g., 32 bits of data), and a multiple bit-level control bus. In some implementations, the ALN may be a packet-switched network configured to transport payloads over the multiple physical buses, and packets may include a header identifying one or more destinations and other information such as sequence identifiers usable to reconstruct a transmission order. The ALN may support multicast from one source to multiple destinations and may provide multiple flow-control classes, such as an end-to-end flow-controlled class (e.g., VC_B) and a locally flow-controlled class (e.g., VC_A).

In some implementations, the two flow-control classes may provide independent forward progress guarantees. For example, a compute unit executing a stream of multi-operand instructions may receive operands from multiple memory units at different rates; if a first memory unit sources operands faster than a second memory unit, input FIFOs associated with the first memory unit may fill and apply back-pressure. Separating the communications into different flow-control classes may allow transmissions of the end-to-end flow-controlled class (VC_B) to make forward progress independent of back-pressure conditions affecting the locally flow-controlled class (VC_A). In some implementations, VC_B packets may be released by a producer after ascertaining that a consumer has space, while VC_A packets may be released without such confirmation and may be used for performance-critical communication where non-overlapping routes can be provided.

FIG. 11B illustrates an example switch unit 1131 usable in the ALN, in accordance with example embodiments of the disclosure. In the example of FIG. 11B, the switch unit 1131 may include a switch element 1141 that performs routing decisions. The switch unit 1131 may have eight interfaces: North (N), South (S), East (E), and West (W) interfaces 1142 for connections between switch units, and Northeast (NE), Southeast (SE), Northwest (NW), and Southwest (SW) interfaces 1143 for connections to configurable units (e.g., PCU and PMU instances). A set of two switch units in each tile quadrant may have connections to an Address Generation and Coalescing Unit (AGCU) that includes multiple address generation (AG) units and a coalescing unit (CU) connected to the multiple address generation units; the coalescing unit arbitrates between the AGs and processes memory requests.

Each of the eight interfaces of a switch unit may include a vector interface, a scalar interface, and a control interface to communicate with the vector network, the scalar network, and the control network, respectively. The switch unit may route packets and/or control pulses among its interfaces based on routing configuration data and may, in some implementations, enforce per-class flow control, perform arbitration among competing inputs, and route packets according to a programmable routing table or routing function specified by configuration data.

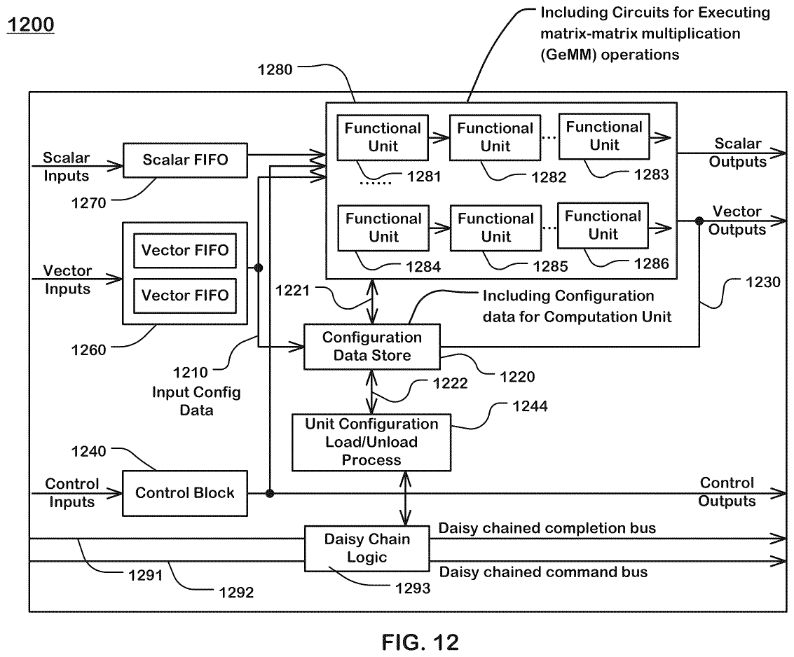

FIG. 12 illustrates a block diagram of an example configurable compute unit (CU) 1200, in accordance with example embodiments of the disclosure. In the example of FIG. 12, the CU 1200 may include a plurality of functional units (1210, 1220, 1230) organized as a multi-stage reconfigurable SIMD pipeline, scalar inputs 1281, vector inputs 1282, control inputs 1283, scalar outputs 1284, vector outputs 1285, control outputs 1286, a vector FIFO 1270, a configuration data store 1240, a control block 1260, and daisy chain logic 1293.

The functional units (1210, 1220, 1230) may be organized as a multi-stage reconfigurable SIMD (Single Instruction, Multiple Data) pipeline. In some implementations, the functional units may include circuits for executing matrix-matrix multiplication (GeMM) operations. The scalar inputs 1281 may be used to communicate single words of data (e.g., 32 bits), and the vector inputs 1282 may be used to communicate chunks of data (e.g., 128 bits). Control inputs and outputs may be used to communicate signals on control lines such as the start or end of execution of a configurable unit. Vector inputs may be buffered in the vector FIFO 1270 and scalar inputs may be buffered in a scalar FIFO; using input FIFOs may decouple timing between data producers and consumers and may simplify inter-configurable-unit control logic by making it robust to input delay mismatches.

The configuration data store 1240 may be configured to store configuration data (e.g., a unit file comprising a plurality of chunks of configuration data) for the functional units. Configuration values may be applied via connections 1221, 1222 to the functional units 1210, 1220, 1230. A unit configuration load/unload process 1244 may execute configuration load operations (e.g., receiving chunks of a unit file via the vector inputs and loading the received chunks into the configuration data store 1240) and/or configuration unload operations (e.g., reading state and/or configuration data out of the store). The CU 1200 may further include the control block 1260 and associated control inputs/outputs. In some implementations, the configuration data store 1240 may comprise serial chains of latches, where the latches may store bits that control configuration of the resources in the configurable unit.

In some implementations, the CU 1200 may include the daisy chain logic 1293 coupled to a daisy chained completion bus 1291 and a daisy chained command bus 1292. The daisy chain logic 1293 may include load complete status logic and may communicate with the unit configuration load/unload process 1244. A master AGCU may transmit program load and unload commands to configurable units in the array over the daisy-chained command bus, and the daisy-chained completion bus may indicate when a load/unload command has been completed.

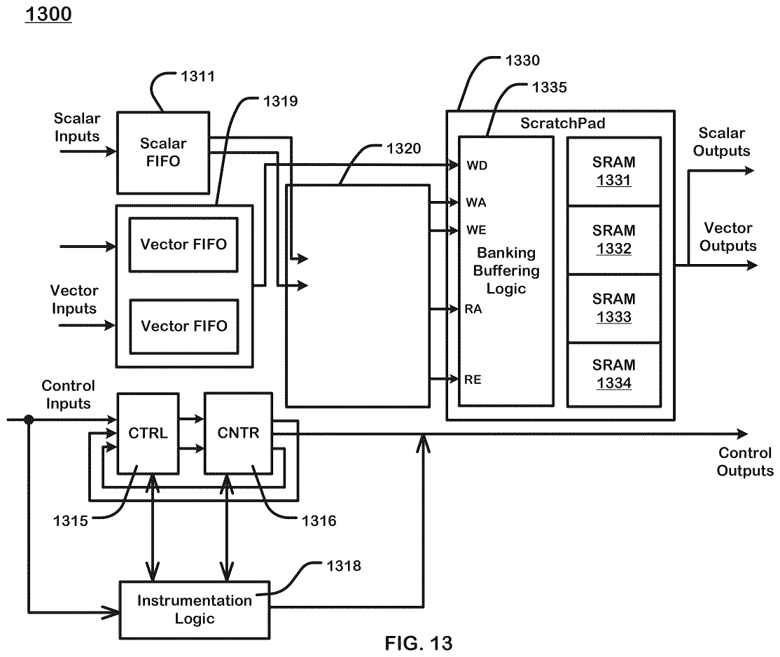

FIG. 13 illustrates a block diagram of an example configurable memory unit 1300, in accordance with example embodiments of the disclosure. In the example of FIG. 13, the configurable memory unit 1300 may include scratchpad memory 1330, banking and buffering logic 1320, a controller 1335, scalar inputs 1311, a scalar FIFO 1319, vector FIFOs, control inputs, a control unit 1315, a programmable counter chain 1316, and instrumentation logic 1318.

In some implementations, the configurable memory unit 1300 may be a pattern memory unit (PMU) including scratchpad memory 1330 distributed within an array of configurable units. PMUs may be used to distribute on-chip memory throughout the array of reconfigurable units, and address calculation within the memory in the PMUs may be performed on the PMU datapath while the core computation may be performed within PCUs.

The scratchpad memory 1330 may be organized into a plurality of memory banks including SRAM bank 1331, SRAM bank 1332, SRAM bank 1333, and SRAM bank 1334, coupled to the banking and buffering logic 1320. The banking and buffering logic 1320 may be configured to operate in several banking modes to support various access patterns. The controller 1335 may coordinate memory operations.

The configurable memory unit 1300 may include the scalar inputs 1311 buffered by the scalar FIFO 1319, vector inputs buffered by the vector FIFOs, and control inputs. The bus interfaces may be used to provide write data (WD) and receive read data. The configurable memory unit 1300 may include a reconfigurable scalar datapath intended for address calculation and control of the scratchpad memory 1330, including write address calculation logic and read address calculation logic that may provide write address (WA), write enable (WE), read address (RA), and read enable (RE) to the banking and buffering logic 1320. Control logic (e.g., control unit 1315 and programmable counter chain 1316) may coordinate accesses and timing; based at least in part on the state of local FIFOs and external control inputs, the control logic may trigger write address computation, read address computation, or both by enabling appropriate counters.

In some implementations, the configurable memory unit 1300 may include the instrumentation logic 1318 configured to collect performance data (e.g., counters, timestamps, or other telemetry) related to memory operations and/or kernel execution. The instrumentation logic 1318 may be coupled to the control inputs and control outputs and may exchange status signals and control signals in support of a control barrier network.

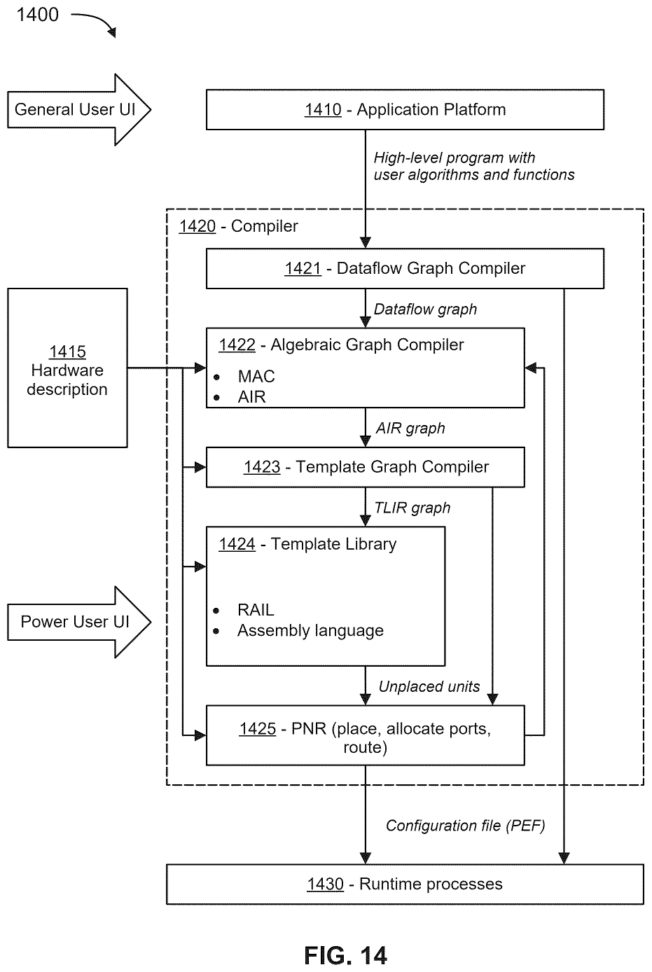

FIG. 14 is a block diagram of a compiler stack 1400 suitable for generating configuration data (e.g., a configuration file (PEF)) for a reconfigurable data processor such as those described herein, in accordance with example embodiments of the disclosure. In the example of FIG. 14, the compiler stack 1400 may include an application platform 1410, a hardware description 1415, and a compiler 1420 having multiple stages including a dataflow graph compiler 1421, an algebraic graph compiler 1422, a template graph compiler 1423, a template library 1424, and a placer and router (PNR) 1425.

In some implementations, the compiler stack 1400 may receive a high-level program (with user algorithms and functions) from the application platform 1410 (e.g., via a general-user UI and/or power-user UI) and may optionally receive the hardware description 1415 describing physical resources of the target reconfigurable data processor. In some implementations, the compiler may produce and transform intermediate representations including a dataflow graph, an algebraic intermediate representation (AIR) graph, and a template-level intermediate representation (TLIR) graph.

In some implementations, the dataflow graph compiler 1421 may convert the high-level program into one or more dataflow graphs that may encode data and control dependencies, and may perform graph-level optimizations such as false data dependency elimination, dead-code elimination, constant folding, operator fusion, elimination of redundant computations, and/or conversion of control-flow constructs into a form suitable for dataflow execution. In some implementations, the template library 1424 may include reusable templates and/or low-level interfaces such as RAIL and/or assembly-language interfaces for power users. The placer and router 1425 may map operations represented by the intermediate representations onto configurable units and interconnect resources of the target hardware and may generate a configuration file (PEF) for loading onto the reconfigurable data processor.

In some implementations, the configuration file may be provided to runtime processes 1430 for execution on the reconfigurable data processor. For example, runtime processes 1430 may load configuration data into configurable units, may orchestrate execution of kernels corresponding to model operators, and may manage data movement between memory and the array, thereby enabling execution of workloads such as those described herein.

The illustrated aspects of the claimed subject matter may also be practiced in distributed computing environments where certain tasks are performed by remote processing devices that are linked through a communications network. In a distributed computing environment, program modules may be located in both local and remote memory storage devices.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

The disclosure is described above with reference to block and flow diagrams of system(s), methods, apparatuses, and/or computer program products according to example implementations of the disclosure. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some implementations of the disclosure.

Computer-executable program instructions may be loaded onto a general purpose computer, a special-purpose computer, a processor, or other programmable data processing apparatus to produce a particular machine, such that the instructions that execute on the computer, processor, or other programmable data processing apparatus for implementing one or more functions specified in the flowchart block or blocks. These computer program instructions may also be stored in a computer-readable memory that may direct a computer or other programmable data processing apparatus to function in a particular manner, such that the instructions stored in the computer-readable memory produce an article of manufacture including instruction that implement one or more functions specified in the flow diagram block or blocks. As an example, implementations of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases may be in communication with each other and/or other databases, such as a centralized database, or other types of data storage devices. When needed, data or information stored in a memory or database may be transmitted to a centralized database capable of receiving data, information, or data records from more than one database or other data storage devices. In other implementations, the databases shown may be integrated or distributed into any number of databases or other data storage devices.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method of processing a batch of samples using a processor comprising compute units, the method comprising:
configuring the processor to implement a plurality of layers including at least a first layer and a second layer, wherein the first layer comprises a plurality of operators including at least a first operator and a second operator; and
executing the plurality of layers for the batch of samples, wherein execution comprises at least one of:
pipelining samples of the batch across the operators of the first layer such that the first operator executes for a first sample simultaneously with the second operator executing for a second sample; or
a sample of the batch beginning execution of the second layer before all samples of the batch have completed the first layer.

2. The method of claim 1, further comprising:
obtaining a schedule defining a sequence of layer executions for the plurality of layers; and
executing the schedule using on-processor orchestration, wherein:
the executing the schedule includes executing the plurality of layers for the batch of samples, and
execution of the schedule repeats without returning control to a host processor between iterations.

3. The method of claim 2, wherein the execution of the schedule repeats with outputs of a completed iteration of the schedule being provided as inputs to a subsequent iteration of the schedule.

4. The method of claim 2, wherein the obtaining obtains a plurality of schedules including the schedule, and wherein the executing includes on-processor orchestration of the execution of the plurality of schedules for a plurality of respective batches including the batch without returning control to the host processor between executions of different schedules of the plurality of schedules.

5. The method of claim 2, wherein:
the repeating continues for a sample of the batch of samples until an end-of-sequence condition is satisfied for the sample,
the end-of-sequence condition comprises detecting an end-of-sequence token in an output of an iteration of the schedule for the sample, and
samples of the batch of samples for which a respective end-of-sequence condition has been detected are excluded from one or more subsequent iterations for other samples of the batch of samples for which an end-of-sequence condition has not been detected.

6. The method of claim 1, wherein:
the batch of samples comprises input sequences,
executing the plurality of layers generates output tokens for the input sequences, and
generating output tokens comprises speculative decoding using a draft model and a target model.

7. The method of claim 6, wherein:
the draft model generates a plurality of candidate tokens for each input sequence, and
the target model verifies the candidate tokens.

8. The method of claim 7, wherein the candidate tokens are ordered in candidate token positions based on an order of generation of the candidate tokens and the verifying the candidate tokens comprises:
executing the target model in a single forward pass that processes all candidate tokens in parallel to produce target outputs corresponding to individual candidate tokens; and
identifying a first position of the candidate token positions at which a target output of the target outputs disagrees with the corresponding individual candidate token, and
accepting the candidate tokens for candidate token positions before the first position and the target output for the first position.

9. The method of claim 1, wherein:
the processor comprises a reconfigurable dataflow processor comprising configurable compute units, and
the operators of the first layer are mapped to the configurable compute units.

10. A non-transitory computer-readable medium storing instructions that, when executed by a processor comprising compute units, cause the processor to perform operations comprising:
configuring the processor to execute one or more kernels;
obtaining a schedule defining a sequence of kernel executions for a batch of samples;
executing the schedule using on-processor orchestration, wherein execution of the schedule repeats without returning control to a host processor between iterations.

11. The non-transitory computer-readable medium of claim 10, wherein the execution of the schedule includes, for a subsequent iteration of the schedule, providing outputs of a completed iteration of the schedule as inputs to the subsequent iteration of the schedule.

12. The non-transitory computer-readable medium of claim 10, wherein:
the obtaining obtains a plurality of schedules including the schedule, and
the executing includes on-processor orchestration of the execution of the plurality of schedules for a plurality of respective batches including the batch without returning control to the host processor between executions of different schedules of the plurality of schedules.

13. The non-transitory computer-readable medium of claim 10, wherein execution of the schedule continues to repeat for a sample of the batch of samples until an end-of-sequence condition is satisfied for the sample.

14. The non-transitory computer-readable medium of claim 13, wherein:
the end-of-sequence condition comprises detecting an end-of-sequence token in an output of an iteration of the schedule for the sample, and
samples of the batch of samples for which a respective end-of-sequence condition has been detected are excluded from one or more subsequent iterations for other samples of the batch of samples for which an end-of-sequence condition has not been detected.

15. The non-transitory computer-readable medium of claim 10, wherein:
the one or more kernels each implement a respective layer comprising a plurality of operators,
executing the schedule comprises processing the batch of samples through the one or more kernels, and
the processing comprises at least one of:
pipelining samples of the batch across the plurality of operators within a kernel such that a first operator executes for a first sample simultaneously with a second operator executing for a second sample; or
streaming between kernels, wherein a sample of the batch begins execution of a subsequent kernel before all samples of the batch have completed a prior kernel,
wherein the one or more kernels implement a draft model and a target model, and the operations further comprise verifying one or more candidate outputs generated by the draft model using the target model to determine one or more accepted outputs.

16. A system comprising:
a processor comprising compute units; and
memory storing configuration data to configure the processor to:
implement a plurality of layers including at least a first layer and a second layer, wherein the first layer comprises a plurality of operators including at least a first operator and a second operator; and
execute the plurality of layers for a batch of samples using at least one of:
pipelining samples of the batch across the operators of the first layer such that the first operator executes for a first sample simultaneously with the second operator executing for a second sample; or
a sample of the batch beginning execution of the second layer before all samples of the batch have completed the first layer.

17. The system of claim 16, wherein:
the memory further stores a schedule defining a sequence of layer executions for the plurality of layers,
the configuration data further configures the processor to execute the schedule using on-processor orchestration, and
execution of the schedule repeats without returning control to a host processor between iterations.

18. The system of claim 16, wherein:
the batch of samples comprises input sequences,
execution of the plurality of layers generates output tokens for the input sequences, and
generating output tokens comprises speculative decoding using a draft model and a target model.

19. The system of claim 17, wherein:
execution of the schedule repeats for a sample of the batch of samples until an end-of-sequence condition is satisfied for the sample,
the end-of-sequence condition comprises detecting an end-of-sequence token in an output of a respective iteration, and
samples for which a respective end-of-sequence condition has been detected are excluded from subsequent iterations.

20. The system of claim 16, wherein:
the processor comprises a reconfigurable dataflow processor comprising configurable compute units, and
the operators of the first layer are mapped to the configurable compute units.
